(19) United States
(12) Patent Application Publication
(10) Pub. No.: US 2007/0213223 A1
(43) Pub. Date: Sep. 13, 2007

(54) Image-forming method using thermal transfer system

(75) Inventors: Kazuaki Oguma, Minami-ashigara-shi (JP); Takuya Arai, Minami-ashigara-shi (JP); Yoshihisa Tsukada, Minami-ashigara-shi (JP); Hisashi Mikoshiba, Minami-ashigara-shi (JP); Toshihide Yoshitani, Minami-ashigara-shi (JP); Masataka Yoshizawa, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/715,878

(22) Filed: Mar. 9, 2007

(30) Foreign Application Priority Data
Mar. 9, 2006 (JP) 2006-064932
Mar. 10, 2006 (JP) 2006-065351

(51) Int. Cl. B41M 5/035

(52) U.S. Cl. 503/227

(57) ABSTRACT

An image-forming method, having: superposing an ink sheet on an image-receiving sheet so that a dye layer of the ink sheet can be contacted with at least one receptor layer of the image-receiving sheet; and providing thermal energy according to image signals given from a thermal head to the superposed two sheets, thereby to form images; wherein the ink sheet has a dye layer that contains a thermally transferable color material on one surface of a substrate, wherein the ink sheet further has (a) a heat-resistant sliding layer on the other surface of the substrate or (b) at least one polyester as a binder component, in which at least a half (molar ratio) of an acid component of the polyester is terephthalic acid; and wherein the image-receiving sheet has, on a support, at least one receptor layer containing e.g., a polymer having at least one vinyl chloride repeating unit.

### FIELD OF THE INVENTION

The present invention relates to an image-forming method using a thermal transfer system (heat-sensitive transfer system).

In particular, the present invention relates to an image-forming method by which a print having an excellent image quality without unevenness can be provided with no fusion between an ink sheet and an image-receiving sheet, even if a high speed printing is performed. More particularly, the present invention relates to an image-forming method by which a print having a high density and an excellent image quality without a failure such as unevenness and wrinkle can be provided with neither fusion between an ink sheet and a thermal head nor fusion between an ink sheet and an image-receiving sheet, even if a high speed printing is performed.

### BACKGROUND OF THE INVENTION

Various heat transfer recording methods have been known so far. Among these methods, dye diffusive transfer recording systems attract remarkable attention as a process that can produce a color hard copy having image qualities closest to that of silver salt photography (see, for example, “Information Recording (hard copy) and New Development of Recording Materials” published by Toray Research Center Inc., 1993, pp. 241-285; and “Development of Printer Material” published by CMC Publishing Co., Ltd., 1995, p. 180). This system is also more advantageous than silver salt photography, because it is a dry system, it enables direct visualization from digital data, and it makes reproduction simply.

In this dye diffusive transfer recording system, a heat-sensitive transfer sheet (hereinafter referred to also as a thermal transfer sheet or an ink sheet) containing dyes is superposed on a heat-sensitive transfer image-receiving sheet (hereinafter referred to also as an image-receiving sheet), and then the ink sheet is heated by a thermal head exothermically controlled by electric signals, in order to transfer the dyes contained in the ink sheet to the image-receiving sheet, thereby recording image information. Three colors: cyan, magenta, and yellow, are used by being overlapped onto one other to record, thereby enabling transferring and recording a color image having continuous variations in color densities.

On the other hand, an example of fields in which new applications of this dye diffusive transfer recording system are being developed, is that of heat transfer recording labels, or heat transfer recording tags, for use in POS (Point Of Sales) systems. It is relatively unusual for this system to be used in severe conditions for a long period of time, in current food label applications and cloth tag applications. However, opportunities to use this system have increased in distribution management applications such as delivery labels and air baggage tags, and it is demanded of this system to enable precise recording of, for example, bar codes, and to provide a high-quality image. Also, it is desired to improve the paper strength of heat transfer recording image-receiving paper, because there is the case in which a recording material is exposed to severe conditions.

JP-A-9-220863 (“JP-A” means unexamined published Japanese patent publication) discloses that crepe paper or extensible paper is used as a support of the image-receiving sheet. However, when this crepe paper or extensible paper is used as the support, there is the problem that moisture is absorbed in the paper during the course of the process from coating step to drying step, and also the moisture remains in the paper after the paper is dried, causing a reduction in the sharpness of a receptor layer over time.

In the image formation that is performed using the above-described thermal transfer sheet with a thermal head, when the processing for the image formation is conducted at a high speed, and if a substrate film is a thermoplastic film such as a polyester film, problems arise that the thermal head fuses the substrate film of an ink sheet because the thermal head has been heated at a high temperature, so that an excellent traveling of the thermal head is deteriorated, and thereby a failure such as breakage and wrinkle occurs in the thermal transfer sheet. Besides, when the processing is conducted at a high speed in the image formation, another problem arises that a time necessary to transfer a heat from the thermal head is so short that it is difficult to obtain a high density image.

### SUMMARY OF THE INVENTION

The present invention resides in an image-forming method comprising the steps of:

superposing a thermal transfer sheet on a heat-sensitive transfer image-receiving sheet so that the following thermal transfer layer of the thermal transfer sheet can be contacted with the following at least one receptor layer of the heat-sensitive transfer image-receiving sheet; and

providing thermal energy in accordance with image signals given from a thermal head to the superposed two sheets, thereby to form a thermal transfer image;

wherein the thermal transfer sheet is (a) the thermal transfer sheet comprising a thermal transfer layer that contains a thermally transferable color material on one surface of a substrate film and a heat-resistant sliding layer that is formed so as to contain a hardener on the other surface of the substrate film, or (b) the thermal transfer sheet comprising a thermal transfer layer containing a thermally transferable color material and at least one polyester as a binder component, in which at least a half (½) by molar ratio of an acid component of said polyester is terephthalic acid; and

wherein the heat-sensitive transfer image-receiving sheet comprises, on a support, at least one receptor layer receiving a color material that is transferred from the above-described thermal transfer sheet, said receptor layer containing a polymer comprising at least one repeating unit derived from vinyl chloride or a polymer that at least one repeating unit is a repeating unit of vinyl chloride.

Other and further features and advantages of the invention will appear more fully from the following description, taken in connection with the accompanying drawings.

### BRIEF DESCRIPTION OF THE DRAWINGS

FIG. 1 is an illustration of a thermal recording apparatus that can be used for heat-sensitive transfer recording according to the present invention.

### DETAILED DESCRIPTION OF THE INVENTION

According to the present invention, there is provided the following means:

(1) An image-forming method comprising the steps of:

superposing a thermal transfer sheet on a heat-sensitive transfer image-receiving sheet so that the following thermal transfer layer of the thermal transfer sheet can be contacted with the following at least one receptor layer of the heat-sensitive transfer image-receiving sheet; and

providing thermal energy in accordance with image signals given from a thermal head to the superposed two sheets, thereby to form a thermal transfer image;

wherein the a thermal transfer sheet is (a) the thermal transfer sheet comprising a thermal transfer layer that contains a thermally transferable color material on one surface of a substrate film and a heat-resistant sliding layer that is formed so as to contain a hardener on the other surface of the substrate film, or (b) the thermal transfer sheet comprising a thermal transfer layer containing a thermally transferable color material and at least one polyester as a binder component, in which at least a half (½) by molar ratio of an acid component of said polyester is terephthalic acid; and

wherein the heat-sensitive transfer image-receiving sheet comprises, on a support, at least one receptor layer receiving a color material that is transferred from the above-described thermal transfer sheet, said receptor layer containing a polymer comprising at least one repeating unit derived from vinyl chloride or a polymer that at least one repeating unit is a repeating unit of vinyl chloride.

(2) The image-forming method as described in the above item (1), comprising the steps of:

superposing a thermal transfer sheet on a heat-sensitive transfer image-receiving sheet so that the following thermal transfer layer of the thermal transfer sheet can be contacted with the following at least one receptor layer of the heat-sensitive transfer image-receiving sheet; and

providing thermal energy in accordance with image signals given from a thermal head to the superposed two sheets, thereby to form a thermal transfer image;

wherein the thermal transfer sheet comprises a thermal transfer layer that contains a thermally transferable color material on one surface of a substrate film, and a heat-resistant sliding layer that is formed so as to contain a hardener on the other surface of the substrate film; and

wherein the heat-sensitive transfer image-receiving sheet comprises, on a support, at least one receptor layer containing a polymer comprising at least one repeating unit derived from vinyl chloride.

(3) The image-forming method as described in the above item (2), wherein the above-described heat-resistant sliding layer contains a polymer that is obtained by a reaction between a compound having two or more isocyanate groups and a polymer.

(4) The image-forming method as described in the above item (2) or (3), wherein a content of said compound having two or more isocyanate groups in the above-described heat-resistant sliding layer is in the range of 5 to 200 parts by mass based on 100 parts by mass of a polymer binder that constitutes the heat-resistant sliding layer.

(5) The image-forming method as described in any one of the above items (2) to (4), wherein a thickness of the above-described heat-resistant sliding layer is in the range of 0.1 to 2.0 μm.

(6) The image-forming method as described in the above item (1), comprising the steps of:

superposing a thermal transfer sheet on a heat-sensitive transfer image-receiving sheet so that the following thermal transfer layer of the thermal transfer sheet can be contacted with the following at least one receptor layer of the heat-sensitive transfer image-receiving sheet; and

providing thermal energy in accordance with image signals given from a thermal head to the superposed two sheets, thereby to form a thermal transfer image;

wherein the thermal transfer sheet comprises a thermal transfer layer containing a thermally transferable color material and at least one polyester as a binder component, in which at least a half (½) by molar ratio of an acid component of said polyester is terephthalic acid; and

wherein the heat-sensitive transfer image-receiving sheet comprises, on a support, at least one receptor layer receiving a color material that is transferred from the above-described thermal transfer sheet, said receptor layer containing a polymer wherein at least one repeating unit is a repeating unit of vinyl chloride.

(7) The image-forming method as described in the above item (6), wherein at least two third (⅔) by molar ratio of an acid component of the above-described polyester is terephthalic acid.

(8) The image-forming method as described in the above item (6), wherein at least three fourth (¾) by molar ratio of an acid component of the above-described polyester is terephthalic acid.

(9) The image-forming method as described in any one of the above items (1) to (8), wherein the above-described thermal transfer sheet contains at least one dye selected from the group consisting of dyes represented by formula (7) and formula (8) set forth below:

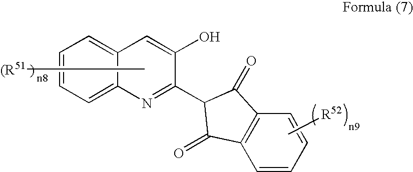

wherein, in formula (7), R⁵¹ and R⁵² each independently represents a substituent; n8 represents an integer of 0 to 5; n9 represents an integer of 0 to 4; when n8 represents an integer of 2 to 5, R⁵¹s may be the same or different from each other; and when n9 represents an integer of 2 to 4, R⁵²s may be the same or different from each other;

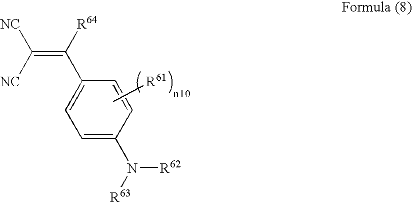

wherein, in formula (8), R⁶¹ represents a substituent; R⁶², R⁶³ and R⁶⁴ each independently represents a hydrogen atom or a substituent; n10 represents an integer of 0 to 4; and when n10 represents an integer of 2 to 4, R⁶¹s may be the same or different from each other.
(10) The image-forming method as described in any one of the above items (1) to (9), wherein the above-described thermal transfer sheet contains at least one dye selected from the group consisting of dyes represented by formula (9), formula (10) and formula (11) set forth below:

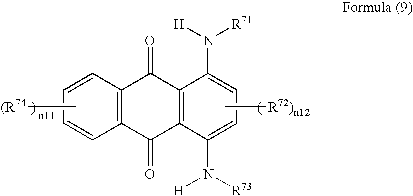

wherein, in formula (9), R⁷¹ and R⁷³ each independently represents a hydrogen atom or a substituent; R⁷² and R⁷⁴ each independently represents a substituent; n11 represents an integer of 0 to 4; n12 represents an integer of 0 to 2; when n11 represents an integer of 2 to 4, R⁷⁴s may be the same or different from each other; and when n12 represents 2, R⁷²s may be the same or different from each other;

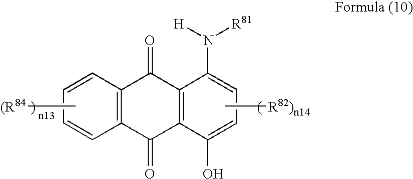

wherein, in formula (10), R⁸¹ represents a hydrogen atom or a substituent; R⁸² and R⁸⁴ each independently represents a substituent; n13 represents an integer of 0 to 4; n14 represents an integer of 0 to 2; when n13 represents an integer of 2 to 4, R⁸⁴s may be the same or different from each other; and when n14 represents 2, R⁸²s may be the same or different from each other;

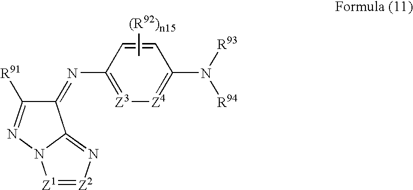

wherein, in formula (11), R⁹¹ represents a hydrogen atom or a substituent; R⁹² represents a substituent; R⁹³ and R⁹⁴ each independently represents a hydrogen atom or a substituent; n15 represents an integer of 0 to 2; when n15 represents 2, R⁹²s may be the same or different from each other; one of Z¹ and Z² represents ═N— and the other represents ═C(R⁹⁵)—; Z³ and Z⁴ each independently represents ═N— or ═C(R⁹⁶)—; and R⁹⁵ and R⁹⁶ each independently represents a hydrogen atom or a substituent.
(11) The image-forming method as described in any one of the above items (1) to (10), wherein the above-described thermal transfer sheet contains at least one dye selected from the group consisting of dyes represented by formula (12) and formula, (13) set forth below:

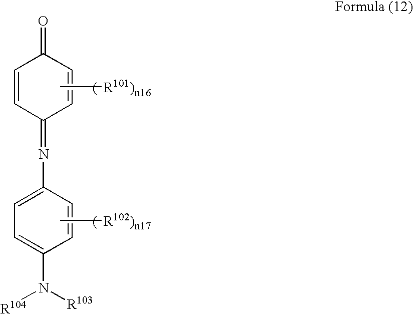

wherein, in formula (12), R¹⁰¹ and R¹⁰² each independently represents a substituent; R¹⁰³ and R¹⁰⁴ each independently represents a hydrogen atom or a substituent; n16 and n17 each independently represents an integer of 0 to 4; when n16 represents an integer of 2 to 4, R¹⁰¹s may be the same or different from each other; and when n17 represents an integer of 2 to 4, R¹⁰²s may be the same or different from each other;

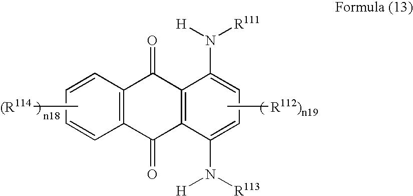

wherein, in formula (13), R¹¹¹ and R¹¹³ each independently represents a hydrogen atom or a substituent; R¹¹² and R¹¹⁴ each independently represents a substituent; n18 represents an integer of 0 to 4; n19 represents an integer of 0 to 2; when n18 represents an integer of 2 to 4, R¹¹⁴s may be the same or different from each other, and when n19 represents 2, R¹¹²s may be the same or different from each other.

(12) The image-forming method as described in any one of the above items (2) to (5) or (9) to (11), wherein a transport speed of the above-described heat-sensitive transfer image-receiving sheet at the time of image formation is at least 125 mm per second.

(13) The image-forming method as described in any one of the above items (1) to (12), wherein the polymer used in the receptor layer of the heat-sensitive transfer image-receiving sheet is a vinyl chloride-vinyl acetate copolymer.

(14) The image-forming method as described in any one of the above items (1) to (13), wherein the polymer used in the receptor layer of the heat-sensitive transfer image-receiving sheet is a polyvinyl chloride copolymer having a vinyl chloride constituent content of 85 to 97% by mass and a polymerization degree of 200 to 800.

(15) The image-forming method as described in any one of the above items (1) to (14), wherein the receptor layer of the heat-sensitive transfer image-receiving sheet comprises a plasticizer.

(16) The image-forming method as described in any one of the above items (1) to (15), wherein the receptor layer of the heat-sensitive transfer image-receiving sheet comprises a releasing agent.

(17) The image-forming method as described in any one of the above items (1) to (16), wherein an amount of the receptor layer to be applied on the support of the heat-sensitive transfer image-receiving sheet is in the range of 0.5 to 10 g/m² (in solid content equivalent).

(18) The image-forming method as described in any one of the above items (1) to (17), wherein an amount of the thermal transfer layer to be applied on the substrate film of the heat-sensitive transfer sheet is in the range of 0.15 to 0.60 g/m² (in solid content equivalent).

(Hereinafter, a first embodiment of the present invention means to include the image-forming method described in the above item (2), and the above items (3) to (5) and (9) to (18) depending on the item (2). A second embodiment of the present invention means to the image-forming method described in the above item (6), and the above items (7) to (18) depending on the item (6).)

The present invention will be explained in detail.

1) Heat-Sensitive Transfer Image-Receiving Sheet

The heat-sensitive transfer image-receiving sheet of the present invention is provided with a dye receiving layer (receptor layer) formed on a support. It is preferable to form an undercoat layer between the receptor layer and the support. As the undercoat layer, for example, a white background control layer, a charge control layer, an adhesive layer and a primer layer are formed. Also, a heat insulation layer is preferably formed between the undercoat layer and the support.

It is preferable that a curling control layer, a writing layer, and a charge-control layer be formed on the backside of the support. Each layer on the backside of the support is applied using a usual method such as a roll coating, a bar coating, a gravure coating, and a gravure reverse coating.

[Receptor Layer]

The receptor layer serves to receive dyes transferred from an ink sheet and to maintain an image formed by these dyes. The image-receiving sheet used in the present invention comprises preferably a polymer comprising a vinyl chloride repeating unit as a main chain that is easily dyed (dyeability receiving polymer, or a receptor polymer capable of being dyed), whereby a high density image can be obtained, even if a high speed printing is performed.

The image-receiving sheet used in the present invention may be provided preferably with at least one receptor layer containing a latex polymer and a water-soluble polymer. The water-soluble polymer which can be scarcely dyed is made to exist between the latex polymers, whereby the dye stuck to the latex polymer can be prevented from diffusing. As a result, it is possible to decrease a variation in the sharpness of the receptor layer with time, whereby a recording image reduced in the variation of a transferred image with time can be formed.

<Dyeability Receiving Polymer>

Examples of the polymer (thermoplastic resin) that may be used in the receptor layer in the present invention include vinyl-series resins such as halogenated polymers (e.g., polyvinyl chloride and polyvinylidene chloride), polyvinyl acetate, ethylene-vinyl acetate copolymer, vinyl chloride-vinyl acetate copolymer, polyacryl ester, polystylene, and polystylene acrylate;

acetal-series resins such as polyvinylformal, polyvinylbutyral and polyvinylacetal;

polyester-series resins such as polyethylene terephthalate, polybutylene terephthalate and polycaprolactone (e.g., PLACCEL H-5 (trade name) manufactured by DAICEL CHEMICAL INDUSTRIES, LTD.);

polycarbonate-series resins;

cellulose-series resins such as cellulose-series resins described in JP-A-4-296595 and JP-A-2002-264543, and cellulose acetate butyrate (e.g., CAB551-0.2 and CAB321-0.1 (each trade name) manufactured by Eastman Chemical Company);

polyolefin-series resins such as polypropylene; and

polyamide-series resins such as urea resins, melamine resins and benzoguanamine resins.

These resins may be used optionally blending with each other in the range of compatibility. Resins used for forming the receptor layer are also disclosed in JP-A-57-169370, JP-A-57-207250 and JP-A-60-25793.

The present invention, preferably the first embodiment of the present invention, is necessary to use a polymer comprising at least one repeating unit derived from vinyl chloride. In present invention, preferably the second embodiment of the present invention, vinyl resins (a simple substance) are preferable among the above-described polymers. More preferred vinyl resins are halogeno-copolymers. Especially preferred halogeno-copolymers are polyvinyl chloride copolymers.

The above-described polymers may be used singly or as a mixture thereof.

The polymer is explained in detail below.

(Polyvinyl Chloride Copolymer)

The polyvinyl chloride copolymer used in the receptor layer is described in more detail.

The polyvinyl chloride copolymer is preferably one having a vinyl chloride constituent content of 85 to 97% by mass and a polymerization degree of 200 to 800. A monomer forming such a copolymer together with vinyl chloride has no particular restrictions, but any monomer may be used as far as it can be copolymerized with vinyl chloride. However, it is particularly preferably vinyl acetate. Accordingly, the polyvinyl chloride copolymer used in the receptor layer is advantageously a vinyl chloride-vinyl acetate copolymer. However, the vinyl chloride-vinyl acetate copolymer is not necessarily constituted of vinyl chloride and vinyl acetate alone, and may include vinyl alcohol and maleic acid constituents. Examples of other monomer constituents of such a copolymer constituted mainly of vinyl chloride and vinyl acetate include vinyl alcohol and its derivatives such as vinyl propionate; acrylic or methacrylic acids and their derivatives such as their methyl, ethyl, propyl, butyl and 2-ethylhexyl esters; maleic acid and its derivatives such as diethyl maleate, dibutyl maleate and dioctyl maleate; vinyl ether derivatives such as methyl vinyl ether, butyl vinyl ether and 2-ethylhexyl vinyl ether; acrylonitrile and methacrylonitrile; and styrene. The ratio of each of the vinyl chloride and vinyl acetate components in the copolymer may be any ratio, but it is preferable that the ratio of the vinyl chloride component is 50 mass % or more of the copolymer. In addition, it is preferable that the ratio of the above-recited constituents other than the vinyl chloride and vinyl acetate is 10 mass % or less of the copolymer.

Examples of such a vinyl chloride-vinyl acetate copolymer include SOLBIN C, SOLBIN CL, SOLBIN CH, SOLBIN CN, SOLBIN C5, SOLBIN M, SOLBIN MF, SOLBIN A, SOLBIN AL, SOLBIN TA5R, SOLBIN TAO, SOLBIN MK6, and SOLBIN TA2 (trade names, manufactured by Nissin Chemical Industry Co., Ltd.); S-LEC A, S-LEC C and S-LEC M (trade names, manufactured by Sekisui Chemical Co., Ltd.); Vinylite VAGH, Vinylite VYHH, Vinylite VMCH, Vinylite VYHD, Vinylite VYLF, Vinylite VYNS, Vinylite VMCC, Vinylite VMCA, Vinylite VAGD, Vinylite VERR and Vinylite VROH (trade names, manufactured by Union Carbide Corporation); and DENKA VINYL 1000GKT, DENKA VINYL 1000L, DENKA VINYL 1000CK, DENKA VINYL 1000A, DENKA VINYL 1000LK₂, DENKA VINYL 1000AS, DENKA VINYL 1000MT₂, DENKA VINYL 1000CSK, DENKA VINYL 1000CS, DENKA VINYL 1000GK, DENKA VINYL 1000GSK, DENKA VINYL. 1000GS, DENKA VINYL 1000LT₃, DENKA VINYL 1000D and DENKA VINYL 1000W (trade names, manufactured by Denki Kagaku Kogyo Kabushiki Kaisha).

<Plasticizer>

For the purpose of enhancing the sensitivity of the receptor layer, a plasticizer (high boiling organic solvent) may also be added.

Examples of such a plasticizer include compounds generally used as plasticizers for vinyl chloride resins, and more specifically monomeric plasticizers such as phthalates, phosphates, adipates and sebacates, and polyester-type plasticizers produced by polymerization of adipic acid or sebacic acid and polyethylene glycol. Although the former plasticizers are generally low in molecular weight, other polymeric plasticizer usable for vinyl chloride resins may be olefin-type special copolymer resins. Examples of resins usable for such a purpose include products marketed under the names of ELVALOY 741, ELVALOY 742, ELVALOY HP443, ELVALOY HP553, ELVALOY EP4015, ELVALOY EP4043, ELVALOY EP4051 (trade names, manufactured by DuPont-Mitsui Polychemicals Co., Ltd.). Such plasticizers can be added to the resins in a proportion of about 100% by mass, but it is appropriate to use them in a proportion of 30% by mass or below in view of bleeding of prints.

The degree of capability of being dyed is defined as follows. Four colors, specifically, yellow, magenta, cyan and black are output so as to form a solid image having 256 gradations on an image-receiving sheet, and the reflection density of the resulting image is measured to define a polymer providing an image having the highest reflection density as a receptor polymer having good capability of being dyed. It is necessary to pay special attention to the capability of being dyed of the receptor polymer because it varies depending on the type of printer and the type of ink sheet.

The glass transition temperature (Tg) of the binder used in the invention is preferably in the range of −30° C. to 100° C., more preferably 0° C. to 90° C., still more preferably 30° C. to 80° C. in view of film forming properties and image storability. A blend of two or more types of polymers can be used as the binder. When two or more polymers are used, the average Tg obtained by summing up the Tg of each polymer weighted by its proportion is preferably within the foregoing range. Also, when phase separation occurs or when a core-shell structure is adopted, the weighted average Tg is preferably within the foregoing range.

The glass transition temperature (Tg) is calculated according to the following equation:
1/Tg=Σ(Xi/Tgi)
wherein, assuming that the polymer is a copolymer composed of n monomers from i=1 to i=n, Xi is a weight fraction of the i-th monomer (ΣXi=1) and Tgi is glass transition temperature (measured in absolute temperature) of a homopolymer formed from the i-th monomer. The symbol Σ means the sum of i=1 to i=n. The value of the glass transition temperature of a homopolymer formed from each monomer (Tgi) is adopted from J. Brandrup and E. H. Immergut, “Polymer Handbook, 3rd. Edition”, Wiley-Interscience (1989).

The polymerization method is preferably a batch polymerization method, a monomer (continuous or divided) addition method, or an emulsion addition method.

<Releasing Agent>

Also, a releasing agent may be compounded in the receptor layer to prevent thermal fusion with a thermal transfer sheet (ink sheet) when an image is formed.

If the image-receiving surface of the heat-sensitive transfer image-receiving sheet lacks a sufficient releasing property, problems of so-called abnormal transfer arises. Examples of the abnormal transfer include a problem that a heat-sensitive transfer sheet and a heat-sensitive transfer image-receiving sheet (image-receiving sheet) mutually fuse by heat from a thermal head when image is formed, and thereby a big noise due to peeling arises at the time of peeling; a problem that a dye layer is entirely transferred; and a problem that the receptor layer is peeled from the support. As a method of solving such problems of releasing property, it is known that various kinds of releasing agents are incorporated in the receptor layer and that a releasing layer is separately disposing on the receptor layer. In the present invention, it is preferable to use a releasing agent in the receptor layer in order to keep more securely the releasing property between the heat-sensitive transfer sheet and the image-receiving sheet at the time of printing images.

As the releasing agent, solid waxes such as polyethylene wax, amide wax and Teflon powder; silicone oil, phosphate-series compounds, fluorine-based surfactants, silicone-based surfactants and others including releasing agents known in the technical fields concerned may be used. Fluorine-series compounds typified by fluorine-based surfactants, silicone-based surfactants and silicone-series compounds such as silicone oil and/or its hardened products are preferably used.

The amount of the releasing agent is preferably 0.2 to 30 parts by mass.

As the silicone oil, straight silicone oil and modified silicone oil or their hardened products may be used. Examples of the straight silicone oil include dimethylsilicone oil, methylphenylsilicone oil and methyl hydrogen silicone oil. Examples of the dimethylsilicone oil include KF96-10, KF96-100, KF96-1000, KF96H-10000, KF96H-12500 and KF96H-100000 (all of these names are trade names, manufactured by Shin-Etsu Chemical Co., Ltd.). Examples of the methylphenylsilicone oil include KF50-100, KF54 and KF56 (all of these names are trade names, manufactured by Shin-Etsu Chemical Co., Ltd.).

The modified silicone oil may be classified into reactive silicone oils and non-reactive silicone oils. Examples of the reactive silicone oils include amino-modified, epoxy-modified, carboxyl-modified, hydroxy-modified, methacryl-modified, mercapto-modified, phenol-modified or one-terminal reactive/hetero-functional group-modified silicone oils. Examples of the amino-modified silicone oil include KF-393, KF-857, KF-858, X-22-3680, X-22-3801C, KF-8010, X-22-161A and KF-8012 (all of these names are trade names, manufactured by Shin-Etsu Chemical Co., Ltd.). Examples of the epoxy-modified silicone oil include KF-100T, KF-101, KF-60-164, KF-103, X-22-343 and X-22-3000T (all of these names are trade names, manufactured by Shin-Etsu Chemical Co., Ltd.). Examples of the carboxyl-modified silicone oil include X-22-162C (trade name, manufactured by Shin-Etsu Chemical Co., Ltd.). Examples of the hydroxy-modified silicone oil include X-22-160AS, KF-6001, KF-6002, KF-6003, X-22-170DX, X-22-176DX, X-22-176D and X-22-176DF (all of these names are trade names, manufactured by Shin-Etsu Chemical Co., Ltd.). Examples of the methacryl-modified silicone oil include X-22-164A, X-22-164C, X-24-8201, X-22-174D and X-22-2426 (all of these names are trade names, manufactured by Shin-Etsu Chemical Co., Ltd.).

Reactive silicone oils may be hardened upon use, and may be classified into a reaction-curable type, photocurable type and catalyst-curable type. Among these types, silicone oil that is the reaction-curable type is particularly preferable. As the reaction-curable type silicone oil, products obtained by reacting an amino-modified silicone oil with an epoxy-modified silicone oil and then by curing are desirable. Also, examples of the catalyst-curable type or photocurable type silicone oil include KS-705F-PS, KS-705F-PS-1 and KS-770-PL-3 (all of these names are trade names, catalyst-curable silicone oils, manufactured by Shin-Etsu Chemical Co., Ltd.) and KS-720 and KS-774-PL-3 (all of these names are trade names, photocurable silicone oils, manufactured by Shin-Etsu Chemical Co., Ltd.). The addition amount of the curable type silicone oil is preferably 0.5 to 30% by mass based on the resin constituting the receptor layer. In the present invention, preferably the first embodiment of the present invention, the releasing agent may be used in an amount of from 2 to 4 mass %, preferably from 2 to 3 mass %, based on 100 parts by mass of polymer comprising at least one repeating unit derived from vinyl chloride. In the present invention, preferably the second embodiment of the present invention, the releasing agent is used preferably in an amount of 2 to 4% by mass and further preferably 2 to 3% by mass based on 100 parts by mass of the polyester resin. If the amount is too small, the releasability cannot be secured without fail, whereas if the amount is excessive, a protective layer is not transferred to the image-receiving sheet resultantly.

Examples of the non-reactive silicone oil include polyether-modified, methylstyryl-modified, alkyl-modified, higher fatty acid ester-modified, hydrophilic special-modified, higher alkoxy-modified or fluorine-modified silicone oils. Examples of the polyether-modified silicone oil include KF-6012 (trade name, manufactured by Shin-Etsu Chemical Co., Ltd.) and examples of the methylstyryl-modified silicone oil include 24-510 and KF41-410 (all of these names are trade names, manufactured by Shin-Etsu Chemical Co., Ltd.). Modified silicones represented by any one of the following Formulae 1 to 3 may also be used.

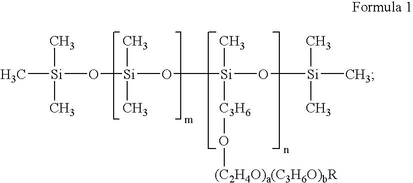

In the Formula 1, R represents a hydrogen atom or a straight-chain or branched alkyl group which may be substituted with an aryl or cycloalkyl group. m and n respectively denote an integer of 2,000 or less, and a and b respectively denote an integer of 30 or less.

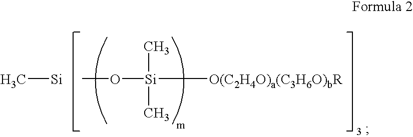

In the Formula 2, R represents a hydrogen atom, or a straight-chain or branched alkyl group which may be substituted with an aryl or cycloalkyl group. m denotes an integer of 2,000 or less, and a and b respectively denote an integer of 30 or less.

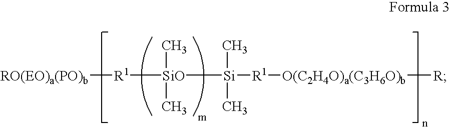

In the Formula 3, R represents a hydrogen atom, or a straight-chain or branched alkyl group which may be substituted with an aryl or cycloalkyl group. m and n respectively denote an integer of 2,000 or less, and a and b respectively denote an integer of 30 or less. R¹ represents a single bond or a divalent linking group, E represents an ethylene group which may be further substituted, and P represents a propylene group which may be further substituted.

Silicone oils such as those mentioned above are described in “SILICONE HANDBOOK” (The Nikkan Kogyo Shimbun, Ltd.) and the technologies described in each publication of JP-A-8-108636 and JP-A-2002-264543 may be preferably used as the technologies to cure the curable silicone oils.

[Undercoat Layer]

An undercoat layer is preferably formed between the receptor layer and the support. As the undercoat layer, for example, a white background regulation layer, a charge regulation layer, an adhesive layer or a primer layer is formed. These layers may be formed in the same manner as those described in, for example, each specification of Japanese Patent Nos. 3,585,599 and 2,925,244.

[Support]

A material of the support (substrate sheet) is not limited in particular, and conventionally known materials may be suitably used according to its various uses.

It is preferable that the substrate sheet not only acts a role of carrying a receptor layer thereon, but also has a mechanical strength of the degree that no handling trouble arise even in the state of heating on account that heat is given to the substrate sheet at the time of thermal transfer.

As a substrate sheet of the heat-sensitive transfer image-receiving sheet for use in the present invention, materials such as papers and plastic films can be used. As the papers, any kinds of paper elements or coated papers may be used. Examples of the papers include not only a wood-free paper, a coat paper, an art paper, a cast coat paper, a wall paper, a lining paper, a cellulose fiber paper and a paper board, but also a resin emulsion- or synthetic rubber latex-impregnated paper, and a synthetic resin-incorporated paper. Of the synthetic papers, preferably used are polystyrene-series and polyolefin-series synthetic papers.

There may be also used various kinds of plastic film or sheet, for example, resin films of polyolefin such as polypropylene; polyester resin films such as a polycarbonate film, a polyethylene naphtharate film, and a polyethylene terephtharate film; polyvinyl chloride film (for example, a rigid polyvinyl chloride film); a polyethylene film; a polyamide film; a polyacrylonitoril film; a polymethacrylate film; polystylene film; a polyether-ether ketone film; a polyethersulfone film; and a polyarylate film. There can be use not only a transparent film, but also a white opaque film that is formed by adding a white pigment and a filler to the plastic film, or a foamed film such as a foamed polypropylene sheet.

These materials of the plastic films may be used solely or as a laminate that is formed by a combination with other materials. Typical examples of the laminates include a laminated synthetic paper composed of a cellulose fiber paper and a synthetic paper, and a laminated synthetic paper composed of a cellulose fiber paper and a plastic film or sheet. These laminated synthetic papers may be composed of two layers. However, the laminate may be composed of three or more multi-layers wherein both sides of a central sheet are laminated with a synthetic paper or a plastic film in order to provide a handling and a textural quality of the substrate. There is no particular limitation in the lamination method, so that there may be used any technique such as dry lamination, wet lamination, and extrusion.

As the substrate, a transparent substrate may be used. In this case, it is preferable in practice to use a drawn polypropylene or polyethylene terephthalate film. These transparent substrate films can be used by loading them in OHP projectors. Further, as for the seal type, a transmissible film can be obtained without deteriorating appearance of the surface of the object to be stuck thereon. It is desired to have transparency at the area on the thermal transfer image-receiving sheet to be stuck, such as a color material-receiving layer and a tackifier layer.

Further, there can be used a substrate film whose surface or back surface has been subjected to a treatment for making it easily adhesive. In the present invention, the substrate film is not limited in particular, but it is preferable to use a plastic substrate film having a high electrification characteristic. A thickness of the substrate film for the thermal transfer image-receiving sheet is not limited in particular, but commonly in the range of about 3 to 300 μm, generally in the range of 10 μm to 300 μm. In the present invention, it is preferable to use a substrate film having a thickness of 75 to 175 μm from a point of view such as a mechanical suitability. Of the above-mentioned sheets, the thickness of the substrate preferably ranges from 50 μm to 120 μm in case of various papers, from 50 μm to 100 μm in case of a white polyethylene terephthalate sheet, and from 30 μm to 80 μm in case of a foamed polypropylene sheet, respectively. In the case where adhesion properties between a substrate film and a layer carried thereon are poor, it is preferable to subject a surface of the substrate film to a treatment for making it easily adhesive, or to a corona discharge treatment.

The amount of the receptor layer to be applied is preferably 0.5 to 10 g/m² (solid basis, hereinafter, the amount to be applied in the present invention is a value on solid basis unless other wise noted).

2) Heat-Sensitive Transfer Sheet

Next, the heat-sensitive (thermal) transfer sheet (ink sheet) for use in the present invention is explained below.

The ink sheet that is used in combination with the above-mentioned heat-sensitive transfer image-receiving sheet at the time when a thermal transfer image is formed, is provided with, on a substrate film (support), a thermal transfer layer containing a diffusion transfer dye (hereinafter, also referred to as “dye layer”). The dye layer is applied using a usual method such as a roll coating, a bar coating, a gravure coating, and a gravure reverse coating.

As a substrate material of the ink sheet, plastic films are suitable such as a polyester film, a polystylene film, a polysulfone film, polyimido film, polyvinyl alcohol film, and cellophane. In a preferable embodiment of the present invention, a thermal transfer dye-providing material is composed of a cyan dye, a magenta dye and a yellow dye successively and repeatedly coated on a polyethylene terephthalate support. The above-described thermal transfer step is performed for each dye in success to form three color transfer image. As a matter of course, if the thermal transfer step is performed by monochrome, a monochromatic transfer image is obtained.

[Thermal Transfer Layer]

The thermal transfer layer (dye layer) of the ink sheet for use in the present invention preferably contains at least one compound (dye) represented by the formula (7) or (8) described below as a yellow dye, at least one compound (dye) represented by the formula (9), (10) or (11) described below as a magenta dye, and at least one compound (dye) represented by formula (12) or (13) described below as a cyan dye.

The following is an explanation of preferable dyes described above.

First, the compound (dye) represented by the formula (7) is explained in detail.

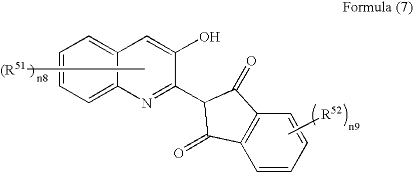

In formula (7), R⁵¹ and R⁵² each independently represents a substituent, n8 represents an integer of 0 to 5, and n9 represents an integer of 0 to 4. When n8 represents an integer of 2 to 5, R⁵¹s may be the same or different from each other; and when n9 represents an integer of 2 to 4, R⁵²s may be the same or different from each other.

In formula (7), R⁵¹ and R⁵² each independently represent a hydrogen atom or a substituent.

Herein, the substituent is described below in more detail. Examples of the substituents represented by R⁵¹ and R⁵² include a halogen atom, an alkyl group (including a cycloalkyl group regardless of ring number), an alkenyl group (including a cycloalkenyl group regardless of ring number), an alkynyl group, an aryl group, a heterocyclic group, a cyano group, an alkoxy group, an aryloxy group, an acyloxy group, a carbamoyloxy group, an alkoxycarbonyloxy group, an aryloxycarbonyloxy group, an amino group (including an alkylamino group and an anilino group), an acylamino group, an aminocarbonylamino group, an alkoxycarbonylamino group, an aryloxycarbonylamino group, a sulfamoylamino group, an alkyl- or aryl-sulfonylamino group, an alkylthio group, an sulfamoyl group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, and an imido group. Each of the above-mentioned substituents may be further substituted.

Herein, R⁵¹ and R⁵² are described in more detail. Examples of the halogen atom represented by R⁵¹ and R⁵² include a fluorine atom, a chlorine atom, a bromine atom, and an iodine atom. Among these, a chlorine atom and a bromine atom are preferably, and a chlorine atom is particularly preferable.

The alkyl group represented by R⁵¹ and R⁵² includes a cycloalkyl group and a bicycloalkyl group. The alkyl group also includes straight or branched chain and substituted or unsubstituted alkyl groups. The straight or branched chain and substituted or unsubstituted alkyl groups are preferably ones having 1 to 30 carbon atoms. Examples thereof include methyl, ethyl, n-propyl, isopropyl, t-butyl, n-octyl, eicosyl, 2-chloroethyl, 2-cyanoethyl and 2-ethylhexyl. The cycloalkyl group includes substituted or unsubstituted cycloalkyl groups. The substituted or unsubstituted cycloalkyl groups are preferably ones having 3 to 30 carbon atoms. Examples thereof include cyclohexyl, cyclopentyl, and 4-n-dodecylcyclohexyl. The bicycloalkyl group is preferably a substituted or unsubstituted bicycloalkyl group having from 5 to 30 carbon atoms, namely, a monovalent group resultant from removing one hydrogen atom of a bicycloalkane having from 5 to 30 carbon atoms. Examples thereof include bicyclo[1,2,2]heptane-2-yl and bicyclo[2,2,2]octane-3-yl. The alkyl group also includes alkyl groups having a multi-ring structure such as a tricyclo structure. The above-mentioned concept of the alkyl group is also applied to an alkyl moiety of the substituents (e.g., an alkyl moiety of the alkylthio group) that are explained below.

The alkenyl group represented by R⁵¹ and R⁵² includes a cycloalkenyl group and a bicycloalkenyl group. The alkenyl group also includes straight or branched chain or cyclic, and substituted or unsubstituted alkenyl groups. The alkenyl group is preferably an alkenyl group having 2 to 30 carbon atoms. Examples thereof include vinyl, allyl, prenyl, geranyl and oleyl. The cycloalkenyl group is preferably a substituted or unsubstituted cycloalkenyl group having 3 to 30 carbon atoms, namely a monovalent group resultant from removing one hydrogen atom of a cycloalkene group having 3 to 30 carbon atoms. Examples thereof include 2-cyclopentene-1-yl and 2-cyclohexene-1-yl. The bicycloalkenyl group includes a substituted or unsubstituted bicycloalkenyl group. The bicycloalkenyl group is preferably a substituted or unsubstituted bicycloalkenyl group having 5 to 30 carbon atoms, namely a monovalent group resultant from removing one hydrogen atom from a bicycloalkene having one double bond. Examples thereof include bicyclo[2,2,1]hept-2-ene-1-yl and bicyclo[2,2,2]oct-2-ene-4-yl.

The alkynyl group represented by R⁵¹ and R⁵² is preferably a substituted or unsubstituted alkynyl group having 2 to 30 carbon atoms. Examples thereof include ethynyl and propargyl.

The aryl group represented by R⁵¹ and R⁵² is preferably a substituted or unsubstituted aryl group having 6 to 30 carbon atoms. Examples thereof include phenyl, p-tolyl, naphthyl, m-chlorophenyl and o-hexadecanoylaminophenyl.

The heterocyclic group represented by R⁵¹ and R⁵² is preferably a monovalent group resultant from removing one hydrogen atom from a substituted or unsubstituted and aromatic or non-aromatic 5- or 6-membered heterocyclic compound. The hetero ring in the heterocyclic group may be a condensed ring. The heterocyclic group is more preferably a 5- or 6-membered aromatic heterocyclic group having 3 to 30 carbon atoms. In place of the heterocyclic group, hetero rings are exemplified below without denotation of their substitution sites: pyridine, pyrazine, pyridazine, pyrimidine, triazine, quinoline, isoquinoline, quinazoline, cinnoline, phthalazine, quinoxaline, pyrrol, indole, furan, benzofuran, thiophene, benzothiophene, pyrrazole, imidazole, benzimidazole, triazole, oxazole, benzoxazole, thiazole, benzothiazole, isothiazole, benzisothiazole, thiadiazole, isoxazole, benzoisoxazole, pyrrolidine, piperidine, piperazine, imidazolidine and thiazoline.

The alkoxy group represented by R⁵¹ and R⁵² includes a substituted or unsubstituted alkoxy group. The substituted or unsubstituted alkoxy group is preferably an alkoxy group having 1 to 30 carbon atoms. Examples of the alkoxy group include methoxy, ethoxy, isopropoxy, n-octyloxy, methoxyethoxy, hydroxyethoxy and 3-carboxypropoxy.

The aryloxy group represented by R⁵¹ and R⁵² is preferably a substituted or unsubstituted aryloxy group having 6 to 30 carbon atoms. Examples of the aryloxy group include phenoxy, 2-methylphenoxy, 4-t-butylphenoxy, 3-nitrophenoxy and 2-tetradecanoylaminophenoxy.

The acyloxy group represented by R⁵¹ and R⁵² is preferably a formyloxy group, a substituted or unsubstituted alkylcarbonyloxy group having. 2 to 30 carbon atoms, and a substituted or unsubstituted arylcarbonyloxy group having 6 to 30 carbon atoms. Examples of the acyloxy group include formyloxy, acetyloxy, pivaloyloxy, stearoyloxy, benzoyloxy and p-methoxyphenyl carbonyloxy.

The carbamoyloxy group represented by R⁵¹ and R⁵² is preferably a substituted or unsubstituted carbamoyloxy group having 1 to 30 carbon atoms. Examples of the carbanoyloxy group include N,N-dimethylcarbamoyloxy, N,N-diethylcarbamoyloxy, morpholino carbonyloxy, N,N-di-n-octylaminocarbonyloxy and N-n-octylcarbamoyloxy.

The alkoxycarbonyloxy group represented by R⁵¹ and R⁵² is preferably a substituted or unsubstituted alkoxycarbonyloxy group having 2 to 30 carbon atoms. Examples of the alkoxycarbonyloxy group include methoxycarbonyloxy, ethoxycarbonyloxy, t-butoxycarbonyloxy and n-octylcarbonyloxy.

The aryloxycarbonyloxy group represented by R⁵¹ and R⁵² is preferably a substituted or unsubstituted aryloxycarbonyloxy group having 7 to 30 carbon atoms. Examples of the aryloxycarbonyloxy group include phenoxycarbonyloxy, p-methoxyphenoxycarbonyloxy and p-n-hexadecyloxyphenoxycarbonyloxy.

The amino group represented by R⁵¹ and R⁵² includes an alkylamino group and an arylamino group. The amino group is preferably a substituted or unsubstituted alkylamino group having 1 to 30 carbon atoms or a substituted or unsubstituted arylamino group having 6 to 30 carbon atoms. Examples of the amino group include amino, methylamino, dimethylamino, anilino, N-methyl-anilino, diphenylamino, hydroxyethylamino, carboxyethylamino, sulfoethylamino and 3,5-dicarboxyanilino.

The acylamino group represented by R⁵¹ and R⁵² is preferably a formylamino group, a substituted or unsubstituted alkylcarbonylamino group having 1 to 30 carbon atoms or a substituted or unsubstituted arylcarbonylamino group having 6 to 30 carbon atoms. Examples of the acylamino group include formylamino, acetylamino, pivaloylamino, lauroylamino, benzoylamino and 3,4,5-tri-n-octyloxyphenylcarbonylamino.

The aminocarbonylamino group represented by R⁵¹ and R⁵² is preferably a substituted or unsubstituted aminocarbonylamino group having 1 to 30 carbon atoms. Examples of the aminocarbonylamino group include carbamoylamino, N,N-dimethylaminocarbonylamino, N,N-diethylaminocarbonylamino and morpholinocarbonylamino.

The alkoxycarbonylamino group represented by R⁵¹ and R⁵² is preferably a substituted or unsubstituted alkoxycarbonylamino group having 2 to 30 carbon atoms. Examples of the alkoxycarbonylamino group include methoxycarbonylamino, ethoxycarbonylamino, t-butoxycarbonylamino, n-octadecyloxycarbonylamino and N-methyl-methoxycarbonylamino.

The aryloxycarbonylamino group represented by R⁵¹ and R⁵² is preferably a substituted or unsubstituted aryloxycarbonylamino group having 7 to 30 carbon atoms. Examples of the aryloxycarbonylamino group include phenoxycarbonylamino, p-chlorophenoxycarbonylamino and m-n-octyloxyphenoxycarbonylamino.

The sulfamoylamino group represented by R⁵¹ and R⁵² is preferably a substituted or unsubstituted sulfamoylamino group having 0 to 30 carbon atoms. Examples of the sulfamoylamino group include sulfamoylamino, N,N-dimethylaminosulfonylamino and N-n-octylaminosulfonylamino.

The alkyl- or aryl-sulfonylamino group represented by R⁵¹ and R⁵² is preferably a substituted or unsubstituted alkylsulfonylamino group having 1 to 30 carbon atoms or a substituted or unsubstituted arylsulfonylamino group having 6 to 30 carbon atoms. Examples of the alkylsulfonylamino group and the arylsulfonylamino group include methylsulfonylamino, butylsulfonylamino, phenylsulfonylamino, 2,3,5-trichlorophenylsulfonylamino and p-methylphenylsulfonylamino.

The alkylthio group represented by R⁵¹ and R⁵² is preferably a substituted or unsubstituted alkylthio group having 1 to 30 carbon atoms. Examples of the alkylthio group include methylthio, ethylthio and n-hexadecylthio.

The sulfamoyl group represented by R⁵¹ and R⁵² is preferably a substituted or unsubstituted sulfamoyl group having 0 to 30 carbon atoms. Examples of the sulfamoyl group include N-ethylsulfamoyl, N-(3-dodecyloxypropyl)sulfamoyl, N,N-dimethylsulfamoyl, N-acetylsulfamoyl, N-benzoylsulfamoyl and N-(N′-phenylcarbamoyl)sulfamoyl.

The alkyl- or aryl-sulfinyl group represented by R⁵¹ and R⁵² is preferably a substituted or unsubstituted alkylsulfinyl group having 1 to 30 carbon atoms or a substituted or unsubstituted arylsulfinyl group having 6 to 30 carbon atoms. Examples of the alkylsulfinyl group and the arylsulfinyl group include methyl sulfinyl, ethyl sulfinyl, phenylsulfinyl and p-methylphenylsulfinyl.

The alkyl- or aryl-sulfonyl group represented by R⁵¹ and R⁵² is preferably a substituted or unsubstituted alkylsulfonyl group having 1 to 30 carbon atoms or a substituted or unsubstituted arylsulfonyl group having 6 to 30 carbon atoms. Examples of the alkylsulfonyl group and the arylsulfonyl group include methylsulfonyl, ethylsulfonyl, phenylsulfonyl and p-toluenesulfonyl.

The acyl group represented by R⁵¹ and R⁵² is preferably a formyl group, a substituted or unsubstituted alkylcarbonyl group having 2 to 30 carbon atoms, a substituted or unsubstituted arylcarbonyl group having 7 to 30 carbon atoms, or a substituted or unsubstituted heterocyclic carbonyl group having 4 to 30 carbon atoms in which one of the carbon atoms in the hetero ring bonds to the carbonyl moiety. Examples of the acyl group include acetyl, pivaloyl, 2-chloroacetyl, stearoyl, benzoyl, p-n-octyloxyphenylcarbonyl, 2-pyridylcarbonyl and 2-furylcarbonyl.

The aryloxycarbonyl group represented by R⁵¹ and R⁵² is preferably a substituted or unsubstituted aryloxycarbonyl group having 7 to 30 carbon atoms. Examples of the aryloxycarbonyl group include phenoxycarbonyl, o-chlorophenoxycarbonyl, m-nitrophenoxycarbonyl and p-t-butylphenoxycarbonyl.

The alkoxycarbonyl group represented by R⁵¹ and R⁵² is preferably a substituted or unsubstituted alkoxycarbonyl group having 2 to 30 carbon atoms. Examples of the alkoxycarbonyl group include methoxycarbonyl, ethoxycarbonyl, t-butoxycarbonyl and n-octadecyloxycarbonyl.

The carbamoyl group represented by R⁵¹ and R⁵² is preferably a substituted or unsubstituted carbamoyl group having 1 to 30 carbon atoms. Examples of the carbamoyl group include carbamoyl, N-methylcarbamoyl, N,N-dimethylcarbamoyl, N,N-di-n-octylcarbamoyl and N-(methylsulfonyl)carbamoyl.

Examples of the aryl- or heterocyclic-azo group represented by R⁵¹ and R⁵² include phenylazo, 4-methoxyphenylazo, 4-pivaloylaminophenylazo and 2-hydroxy-4-propanoylphenylazo.

Examples of the imido group represented by R⁵¹ and R⁵² include N-succinimido and N-phthalimido.

R⁵¹ and R⁵² each independently preferably represent a hydrogen atom, a substituted or unsubstituted alkyl group, a substituted or unsubstituted alkenyl group, a substituted or unsubstituted aryl group, or a substituted or unsubstituted heterocyclic group; more preferably a hydrogen atom or a substituted or unsubstituted alkyl group; and further preferably a hydrogen atom or a substituted or unsubstituted alkyl group having 1 to 6 carbon atoms.

R⁵¹ preferably represents a hydrogen atom, a substituted or unsubstituted alkyl group, a substituted or unsubstituted alkenyl group, a substituted or unsubstituted aryl group or a substituted or unsubstituted heterocyclic group; more preferably a hydrogen atom or a substituted or unsubstituted alkyl group; further preferably a hydrogen atom or a substituted or unsubstituted alkyl group having 1 to 6 carbon atoms; and most preferably an alkyl group having 1 to 6 carbon atoms.

R⁵² preferably represents a hydrogen atom, a substituted or unsubstituted alkyl group, a substituted or unsubstituted alkenyl group, a substituted or unsubstituted aryl group or a substituted or unsubstituted heterocyclic group; more preferably a hydrogen atom or a substituted or unsubstituted alkyl group; more preferably an aryloxycarbonyl group having 6 to 10 carbon atoms, an alkoxycarbonyl group having 1 to 6 carbon atoms or a substituted or unsubstituted carbamoyl group; and most preferably a substituted carbamoyl group.

n8 is an integer of 0 to 5, preferably an integer of 0 to 3; more preferably an integer of 0 to 2; and further preferably an integer of 0 or 1.

n9 is an integer of 0 to 4, preferably an integer of 0 to 3; and more preferably an integer of 0 to 2.

The following is an explanation about a preferable combination of various substituents that a dye represented by formula (7) may have: A preferred compound is a compound in which at least one of the substituents is the above-described preferable substituent. A more preferred compound is a compound in which many various substituents are the above-described preferable substituents. The most preferred compound is a compound in which all substituents are the above-described preferable substituents.

In the compound represented by formula (7), it is preferable that R⁵¹ is an alkyl group having 1 to 6 carbon atoms; R⁵² is a substituted or unsubstituted carbamoyl group, an aryloxycarbonyl group having 6 to 10 carbon atoms or an alkoxycarbonyl group having 1 to 6 carbon atoms; n8 is an integer of 0 to 3; and n9 is an integer of 0 to 3. It is more preferable that R⁵¹ is an alkyl group having 1 to 6 carbon atoms; R⁵² is a substituted or unsubstituted carbamoyl group, an aryloxycarbonyl group having 6 to 10 carbon atoms or an alkoxycarbonyl group having 1 to 6 carbon atoms; n8 is an integer of 0 to 2; and n9 is an integer of 0 to 2. It is further preferable that R⁵¹ is an alkyl group having 1 to 6 carbon atoms, R⁵² is a substituted or unsubstituted carbamoyl group, an aryloxycarbonyl group having 6 to 10 carbon atoms or an alkoxycarbonyl group having 1 to 6 carbon atoms; n8 is an integer of 0 or 1; and n9 is an integer of 0 to 2.

Next, the compound (dye) represented by formula (8) is explained in detail.

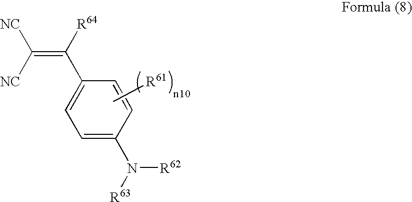

In formula (8), R⁶¹ represents a substituent, and R⁶², R⁶³ and R⁶⁴ each independently represents a hydrogen atom or a substituent. Examples of the substituents each represented by R⁶¹ to R⁶⁴ include those given as examples of the substituents of the above-described R⁵¹ and R⁵² of the formula (7). n10 represents an integer of 0 to 4. When n10 represents an integer of 2 to 4, R⁶¹s may be the same or different from each other.

R⁶¹ preferably represents a hydrogen atom, a substituted or unsubstituted alkyl group, a substituted or unsubstituted alkenyl group, a substituted or unsubstituted aryl group or a substituted or unsubstituted heterocyclic group; more preferably a hydrogen atom or a substituted or unsubstituted alkyl group; further preferably a hydrogen atom or a substituted or unsubstituted alkyl group having 1 to 6 carbon atoms; and most preferably an alkyl group having 1 to 6 carbon atoms.

R⁶² and R⁶³ each independently preferably represent a hydrogen atom, a substituted or unsubstituted alkyl group, a substituted or unsubstituted alkenyl group, a substituted or unsubstituted aryl group, or a substituted or unsubstituted heterocyclic group; more preferably a hydrogen atom or a substituted or unsubstituted alkyl group; and further preferably a hydrogen atom or a substituted or unsubstituted alkyl group having 1 to 6 carbon atoms.

R⁶⁴ preferably represents a hydrogen atom, a substituted or unsubstituted alkyl group, a substituted or unsubstituted alkenyl group, a substituted or unsubstituted aryl group or a substituted or unsubstituted heterocyclic group; more preferably a hydrogen atom or a substituted or unsubstituted alkyl group; further preferably a hydrogen atom or a substituted or unsubstituted alkyl group having 1 to 6 carbon atoms; and most preferably a hydrogen atom.

n10 is an integer of 0 to 4, and preferably an integer of 0 or 1.

The following is an explanation about a preferable combination of various substituents (atoms) that a dye represented by formula (8) may have: A preferred compound is a compound in which at least one of the substituents is the above-described preferable substituent. A more preferred compound is a compound in which many various substituents are the above-described preferable substituents. The most preferred compound is a compound in which all substituents are the above-described preferable substituents.

In the compound represented by formula (8), it is preferable that R⁶¹ is a substituted or unsubstituted alkyl group having 1 to 6 carbon atoms, R⁶² is a substituted or unsubstituted alkyl group having 1 to 6 carbon atoms, R⁶³ is a substituted or unsubstituted alkyl group having 1 to 6 carbon atoms, R⁴ is a hydrogen atom, and n10 is an integer of 0 to 4. It is more preferable that R⁶¹ is a substituted or unsubstituted alkyl group having 1 to 6 carbon atoms, R⁶² is a substituted or unsubstituted alkyl group having 1 to 6 carbon atoms, R⁶³ is a substituted or unsubstituted alkyl group having 1 to 6 carbon atoms, R⁶⁴ is a hydrogen atom, and n10 is 0 or 1.

Next, the compounds (dyes) represented by formula (9) or (10) are explained in detail.

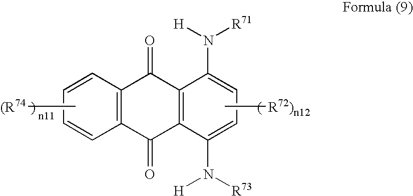

In formula (9), R⁷¹ and R⁷³ each independently represents a hydrogen atom or a substituent, R⁷² and R⁷⁴ each independently represents a substituent, n11 represents an integer of 0 to 4, and n12 represents an integer of 0 to 2. When n11 represents an integer of 2 to 4, R⁷⁴s may be the same or different from each other. When n12 represents 2, R⁷²s may be the same or different from each other. Examples of the substituents each represented by R⁷¹ to R⁷⁴ include those given as examples of the substituent each represented by R⁵¹ and R⁵² of the formula (7).

Examples of the substituent represented by R⁷¹ and R⁷³ include those given as examples of the substituents as described about R⁶² and R⁶³, and preferable examples thereof are also same. R⁷¹ and R⁷³ each are more preferably a hydrogen atom or a substituted or unsubstituted alkyl group having 1 to 6 carbon atoms, and further preferably a hydrogen atom.

Examples of the substituent represented by R⁷² and R⁷⁴ include those given as examples of the substituent as described about R⁵¹. R⁷² and R⁷⁴ each independently are more preferably an alkoxy group, an aryloxy group, an acyloxy group, a carbamoyloxy group, an alkoxycarbonyloxy group or an aryloxycarbonyloxy group; and further preferably an alkoxy group and an aryloxy group. R⁷² is further more preferably an aryloxy group. Each of these groups may be further substituted.

n11 is an integer of 0 to 4, and preferably an integer of 0.

n12 is an integer of 0 to 2, and preferably an integer of 2.

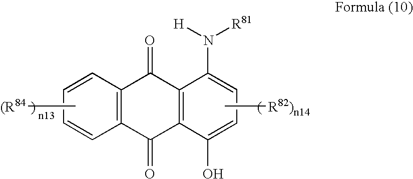

In formula (10), R⁸¹ represents a hydrogen atom or a substituent, R⁸² and R⁸⁴ each independently represents a substituent, n13 represents an integer of 0 to 4, and n14 represents an integer of 0 to 2. When n13 represents an integer of 2 to 4, R⁸⁴s may be the same or different from each other. When n14 represents 2, R¹²s may be the same or different from each other. Examples of the substituents each represented by R⁸¹, R⁸² and R⁸⁴ include those given as examples of the substituent each represented by R⁵¹ and R⁵² of the formula (7).

Examples of the substituent represented by R⁸¹ include those given as examples of the substituents as described about R² and R⁶³, and preferable examples thereof are also same. R⁸¹ is more preferably a hydrogen atom or a substituted or unsubstituted alkyl group having 1 to 6 carbon atoms, and further preferably a hydrogen atom.

Examples of the substituent represented by R⁸² and R⁴ include those given as examples of the substituent as described about R⁵¹. R⁸² and R⁸⁴ each independently are more preferably an alkoxy group, an aryloxy group, an acyloxy group, a carbamoyloxy group, an alkoxycarbonyloxy group and an aryloxycarbonyloxy group; and further preferably an alkoxy group and an aryloxy group. R⁸² is furthermore preferably an aryloxy group. Each of these groups may be further substituted.

n13 is an integer of 0 to 4, preferably an integer of 0 or 1, and further preferably an integer of 0.

n14 is an integer of 0 to 2, preferably an integer 0 or 1, and further preferably an integer of 1.

The following is an explanation about a preferable combination of various substituents (atoms) that a dye represented by formula (9) or (10) may have: A preferred compound is a compound in which at least one of the substituents is the above-described preferable substituent. A more preferred compound is a compound in which many various substituents are the above-described preferable substituents. The most preferred compound is a compound in which all substituents are the above-described preferable substituents.

In the compound represented by formula (9), it is preferable that R⁷¹ is a hydrogen atom, R⁷² is an aryloxy group, R⁷³ is a hydrogen atom, n11 is an integer of 0, and n12 is an integer of 0 to 2. It is more preferable that R⁷¹ is a hydrogen atom, R⁷² is an aryloxy group, R⁷³ is a hydrogen atom, n11 is integer of 0, and n12 is an integer of 2.

In the compound represented by formula (10), it is preferable that R⁸¹ is a hydrogen atom, R⁸² is an aryloxy group, n13 is an integer of 0, and n14 is an integer of 1 or 2. It is more preferable that R⁸¹ is a hydrogen atom, R⁸² is an aryloxy group, n13 is an integer of 0, and n14 is an integer of 1. It is further preferable that R⁸¹ is a hydrogen atom, R⁸² is an aryloxy group, n13 is an integer of 0, n14 is an integer of 1, and said R⁸² is positioned at ortho-site to the amino group.

Next, the dye represented by formula (11) is explained in detail.

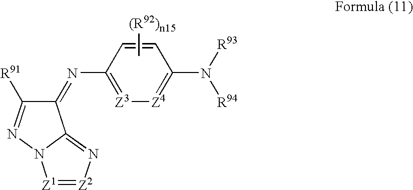

In formula (11), R⁹¹ represents a hydrogen atom or a substituent, R⁹² represents a substituent, R⁹³ and R⁹⁴ each independently represents a hydrogen atom or a substituent, and n15 represents an integer of 0 to 2. When n15 represents 2, R⁹²s may be the same or different from each other. One of Z¹ and Z² represents ═N— and the other represents ═C(R⁹⁵)—. Z³ and Z⁴ each independently represents ═N— or ═C(R⁹⁶)—. R⁹⁵ and R⁹⁶ each independently represents a hydrogen atom or a substituent. Examples of the substituents each represented by R⁹¹ to R⁹⁶ include those given as examples of the substituent each represented by R⁵¹ and R⁵² of the formula (7).

R⁹¹ is preferably a hydrogen atom, a substituted or unsubstituted alkyl group, a substituted or unsubstituted alkenyl group, a substituted or unsubstituted aryl group, a substituted or unsubstituted heterocyclic group or a substituted or unsubstituted amino group; more preferably a substituted or unsubstituted alkyl group having 1 to 6 carbon atoms or a substituted or unsubstituted aryl group having 6 to 10 carbon atoms; and further preferably a substituted or unsubstituted alkyl group.

Examples of R⁹² include those given as examples of the substituent as described about R⁵¹, and preferable examples thereof are also same. R⁹² is more preferably a hydrogen atom or a substituted or unsubstituted alkyl group having 1 to 6 carbon atoms.

Examples of the substituent represented by R⁹³ and R⁹⁴ include those given as examples of the substituents as described about R⁶² and R⁶³, and preferable examples thereof are also same. R⁹³ and R⁹⁴ each are preferably a hydrogen atom and a substituted or unsubstituted alkyl group having 1 to 6 carbon atoms, and further preferably a substituted or unsubstituted alkyl group having 1 to 6 carbon atoms.

One of Z¹ and Z² represent ═N— and the other represents ═C(R⁹⁵)—, in which R⁹⁵ represent a hydrogen atom or a substituent. It is preferable that Z¹ represent ═C(R⁹⁵)— and Z² represents ═N—.

Z³ and Z⁴ each independently represent ═N— or ═C(R⁹⁶)—, in which R⁹⁶ represents a hydrogen atom or a substituent. It is preferable that Z³ represents ═C(R⁹⁶)— and Z⁴ represents ═N—.

Examples of the substituent according to R⁹⁵ and R⁹⁶ include those given as examples of the substituent as described about R⁵¹, and preferable examples thereof are also same. R⁹⁵ and R⁹⁶ are more preferably a hydrogen atom or a substituted or unsubstituted alkyl group. R⁹⁶ is more preferably a hydrogen atom, a substituted or unsubstituted alkyl group, or a substituted or unsubstituted aryl group.

n15 is an integer of 0 to 2, and preferably an integer of 0.

The following is an explanation about a preferable combination of various substituents (atoms) that a dye represented by formula (11) may have: A preferred compound is a compound in which at least one of the substituents is the above-described preferable substituent. A more preferred compound is a compound in which many various substituents are the above-described preferable substituents. The most preferred compound is a compound in which all substituents are the above-described preferable substituents.

In the compound represented by formula (11), it is preferable that one of Z¹ and Z² is ═C(R⁹⁵)— and the other is ═N—, Z³ is ═C(R⁹⁶)—, Z⁴ is ═N—, R⁹¹ is a substituted or unsubstituted alkyl group, R⁹² is a substituted or unsubstituted alkyl group, R⁹³ is a substituted or unsubstituted alkyl group, R⁹⁴ is a substituted or unsubstituted alkyl group, R⁹⁵ is a hydrogen atom, a substituted or unsubstituted alkyl group or a substituted or unsubstituted aryl group, and R⁹⁶ is a hydrogen atom, a substituted or unsubstituted alkyl group or a substituted or unsubstituted aryl group. It is more preferable that Z¹ is ═C(R⁹⁵)—, Z² is ═N—, Z³ is ═C(R⁹⁶)—, Z⁴ is ═N—, R⁹¹ is a substituted or unsubstituted alkyl group, R⁹² is a substituted or unsubstituted alkyl group, R⁹³ is a substituted or unsubstituted alkyl group, R⁹⁴ is a substituted or unsubstituted alkyl group, R⁹⁵ is a hydrogen atom, a substituted or unsubstituted alkyl group or a substituted or unsubstituted aryl group, R⁹⁶ is a hydrogen atom, a substituted or unsubstituted alkyl group or a substituted or unsubstituted aryl group. In the above combinations, it is also preferable that n15 is an integer of 0.

Next, the dyes represented by formula (12) or (13) are explained in detail.

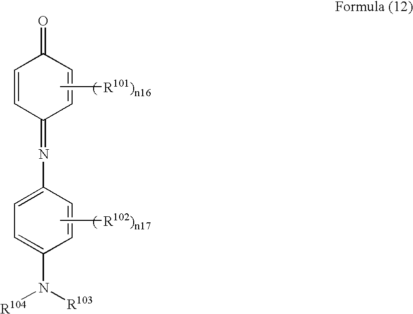

In formula (12), R¹⁰¹ and R¹⁰² each independently represents a substituent, R¹⁰³ and R¹⁰⁴ each independently represents a hydrogen atom or a substituent. Examples of the substituents each represented by R¹⁰¹ to R¹⁰⁴ include those given as examples of the substituents each represented by R⁵¹ and R⁵² of the formula (7). n16 and n17 each independently represents an integer of 0 to 4. When n16 represents an integer of 2 to 4, R¹⁰¹s may be the same or different from each other. When n17 represents an integer of 2 to 4, R¹⁰²s may be the same or different from each other.

Examples of R¹⁰¹ include those given as examples of the substituent as described about R⁵¹, and preferable examples thereof are also same. R¹⁰¹ is more preferably an amino group (including an alkylamino group and an anilino group), an acylamino group, an aminocarbonylamino group, an alkoxycarbonylamino group, an aryloxycarbonylamino group, a sulfamoylamino group, an alkyl- or aryl-sulfonylamino group, a substituted or unsubstituted alkyl group or a halogen atom; further preferably a chlorine atom, a substituted or unsubstituted alkyl group having 1 to 6 carbon atoms, or an acylamino group; furthermore preferably an acylamino group; and furthermore preferably an acylamino group positioned at ortho-position to the O═ group.

Examples of R¹⁰² include those given as examples of the substituent as described about R⁵¹, and preferable examples thereof are also same. R¹⁰² is more preferably a substituted or unsubstituted alkyl group or a substituted or unsubstituted alkoxy group.

Examples of the substituents of R¹⁰³ and R¹⁰⁴ include those given as examples of the substituents as described about R⁶² and R⁶³, and preferable examples thereof are also same. R¹⁰³ and R¹⁰⁴ each are more preferably a substituted or unsubstituted alkyl group or a substituted or unsubstituted aryl group, and furthermore preferably a substituted or unsubstituted alkyl group.

n16 is an integer of 0 to 4, and preferably an integer of 1 to 3.

n17 is an integer of 0 to 4, preferably an integer of 0 to 2, and more preferably an integer of 0 or 1.

In the compound represented by formula (12), it is preferable that R^{10l} is a chlorine atom, a substituted or unsubstituted alkyl group having 1 to 6 carbon atoms, or an acylamino group; R¹⁰² is a substituted or unsubstituted alkyl group having 1 to 6 carbon atoms or a substituted or unsubstituted alkoxy group having 1 to 6 carbon atoms; R¹⁰³ is a substituted or unsubstituted alkyl group having 1 to 6 carbon atoms; R¹⁰⁴ is a substituted or unsubstituted alkyl group having 1 to 6 carbon atoms; n16 is an integer of 0 to 4; and n17 is an integer of 0 to 2. It is more preferable that R¹⁰¹ is a chlorine atom, a substituted or unsubstituted alkyl group having 1 to 6 carbon atoms, or an acylamino group (that is positioned at ortho-position to the carbonyl group); R¹⁰² is a substituted or unsubstituted alkyl group having 1 to 6 carbon atoms or a substituted or unsubstituted alkoxy group having 1 to 6 carbon atoms; R¹⁰³ is a substituted or unsubstituted alkyl group having 1 to 6 carbon atoms; R¹⁰⁴ is a substituted or unsubstituted alkyl group having 1 to 6 carbon atoms; n16 is an integer of 1 to 3; and n17 is an integer of 0 or 1.

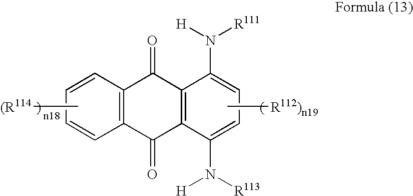

In formula (13), R¹¹¹ and R¹¹³ each independently represents a hydrogen atom or a substituent, R¹¹² and R¹¹⁴ each independently represents a substituent, n18 represents an integer of 0 to 4, n19 represents an integer of 0 to 2. When n18 represents an integer of 2 to 4, R¹¹⁴s may be the same or different from each other. When n19 represents 2, R¹¹²s may be the same or different from each other. Examples of the substituents each represented by R¹¹¹ to R¹¹⁴ include those given as examples of the substituents each represented by R⁵¹ and R⁵² of the formula (7).

Examples of the substituent represented by R¹¹¹ and R¹¹³ include those given as examples of the substituents as described about R⁶² and R⁶³, and preferable examples thereof are also same. R¹¹¹ and R¹¹³ each are more preferably a hydrogen atom, a substituted or unsubstituted alkyl group having 1 to 6 carbon atoms, or a substituted or unsubstituted aryl group. R¹¹¹ is further preferably a substituted or unsubstituted alkyl group having 1 to 6 carbon atoms. R¹¹³ is further preferably a substituted or unsubstituted aryl group having 6 to 10 carbon atoms.

Examples of R¹¹² and R¹¹⁴ include a hydrogen atom and a substituent described about R⁵¹ of formula (7), and a preferable range is also the same as R⁵¹. More preferred is a hydrogen atom.

n18 represents an integer of 0 to 4, and preferably 0.

n19 represents an integer of 0 to 2, and preferably 0.

The following is an explanation about a preferable combination of various substituents (atoms) that a dye represented by formula (12) or (13) may have: A preferred compound is a compound in which at least one of the substituents is the above-described preferable substituent. A more preferred compound is a compound in which many various substituents are the above-described preferable substituents. The most preferred compound is a compound in which all substituents are the above-described preferable substituents.

In the compound represented by formula (7), it is preferable that R¹¹¹ is a substituted or unsubstituted alkyl group having 1 to 6 carbon atoms or a substituted or unsubstituted aryl group having 6 to 10 carbon atoms, R¹¹³ is a substituted or unsubstituted alkyl group having 1 to 6 carbon atoms or a substituted or unsubstituted aryl group having 6 to 10 carbon atoms, and both n18 and n19 are 0. It is more preferable that R¹¹¹ is a substituted or unsubstituted alkyl group having 1 to 6 carbon atoms, R¹¹³ is a substituted or unsubstituted aryl group having 6 to 10 carbon atoms, and both n18 and n19 are 0.

Specific examples of the dyes represented by formulas (7) to (13) are shown below. However, the present invention should not be construed as being limited to the compounds set forth below.

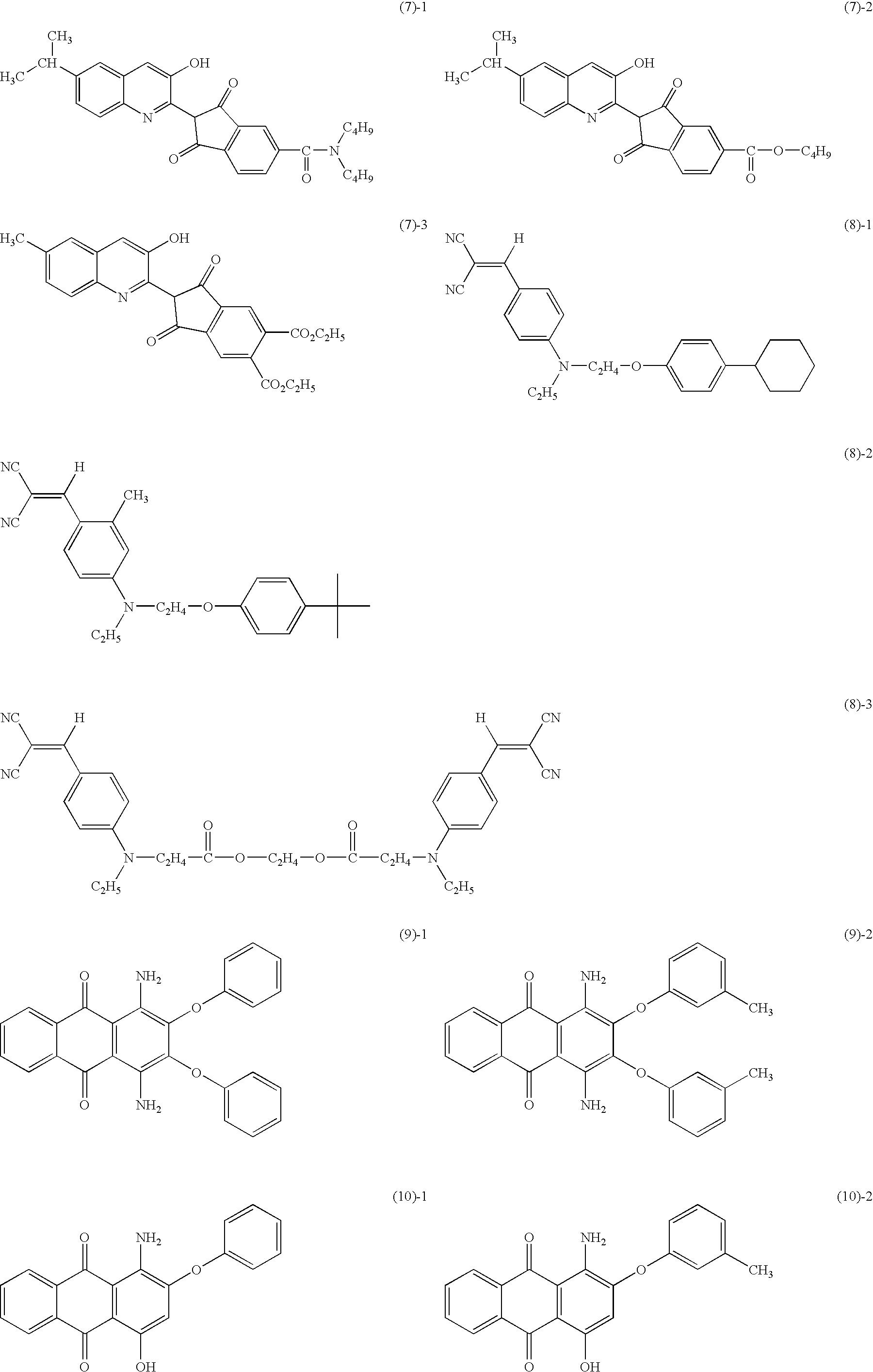

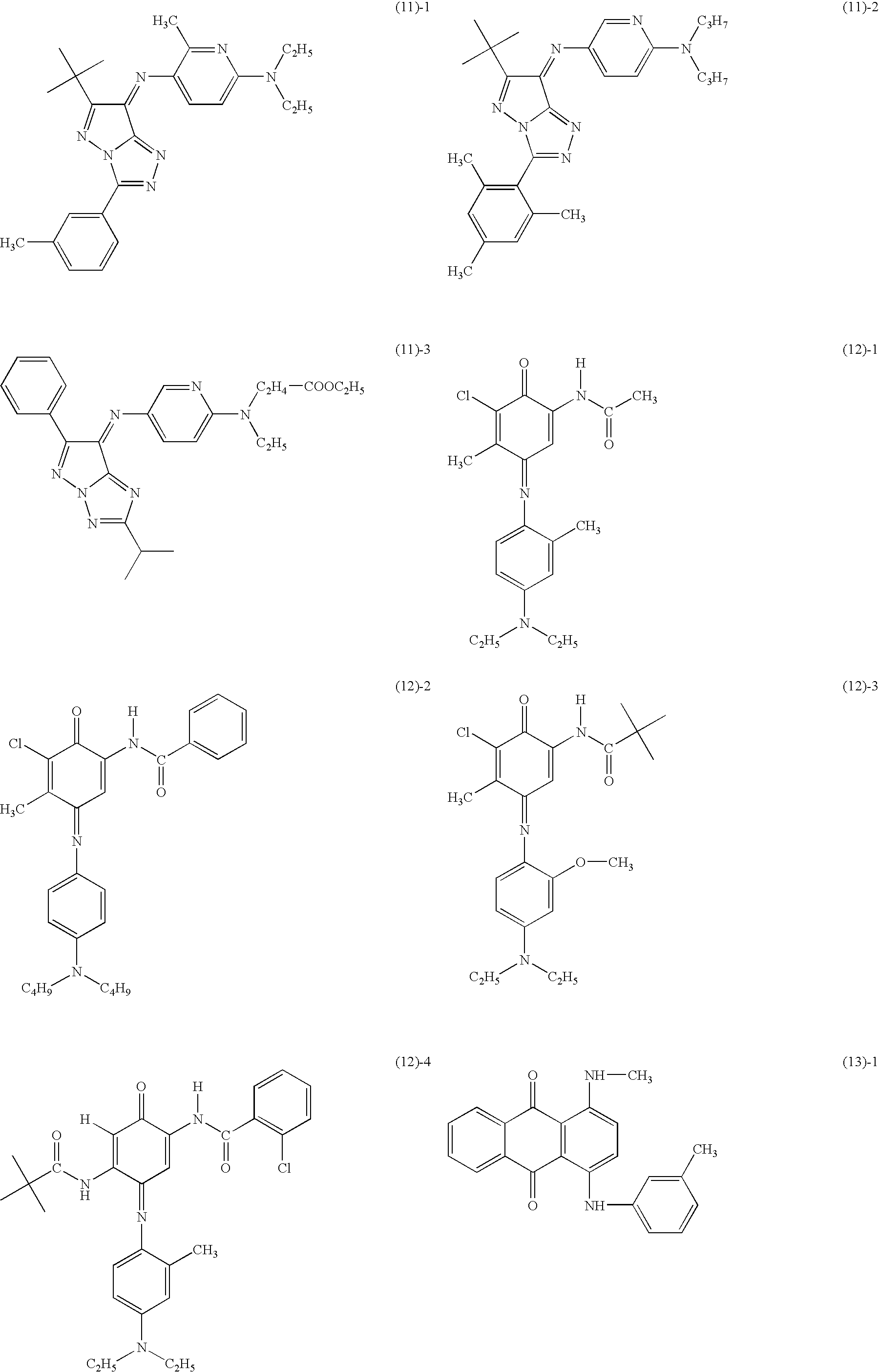

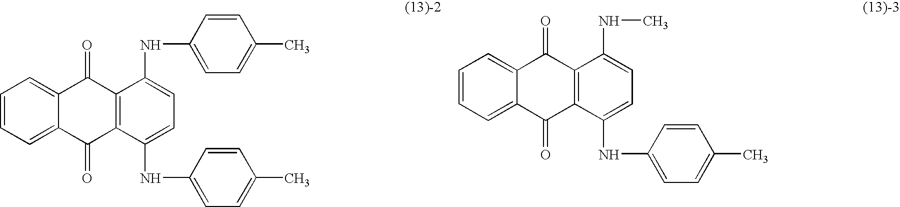

Among the dyes represented by formulae (7) to (13), one(s) that is not sold at a market can be synthesized according to the method described in, for example, U.S. Pat. Nos. 4,757,046 and 3,770,370, German Patent 2316755, JP-A-2004-51873, JP-A-7-137455, JP-A-61-31292, J. Chem. Soc. Perkin transfer 1, 2047 (1977) and “Merocyanine Dye—Doner Element Used in Thermal Dye Transfer” by Champan.

The compounds represented by any one of the formulae (7) to (13) each are contained in the thermal transfer layer (dye layer) of the heat-sensitive transfer sheet (ink sheet) in an amount of preferably 10 to 90 mass %, more preferably 20 to 80 mass %, based on the thermal transfer layer.

A coating amount of the thermal transfer layer in the heat-sensitive transfer sheet (ink sheet) is preferably in the range of 0.1 to 1.0 g/m² (in solid content equivalent), and further preferably in the range of 0.15 to 0.60 g/m². Hereinafter, the term “coating amount” used herein is expressed by a solid content equivalent value, unless it is indicated differently in particular.

A film thickness of the dye layer is preferably in the range of 0.1 to 2.0 μm, and further preferably in the range of 0.1 to 1.0 μm.

Preferred examples of a binder used in the thermal transfer sheet include cellulose resins such as ethyl cellulose, hydroxyethyl cellulose, ethyl hydroxycellulose, hydroxypropyl cellulose, methyl cellulose, cellulose acetate and cellulose butyrate; vinyl resins such as polyvinyl alcohol, polyvinyl acetate, polyvinyl butyral, polyvinyl acetal, polyvinyl pyrrolidone and polyacrylamide; polyester resins; and phenoxy resins. Especially preferred examples of these binders are butyral resins and polyester resins from a point of view such as a heat resistance property and a transfer property of a dye.

In the present invention, preferably the second embodiment of the present invention, at least one polyester (resin) is preferably contained as a component of a binder component in the thermal transfer layer. More preferred polyester resins are those wherein at least a half (½) by molar ratio of an acid component of said polyester is terephthalic acid. Furthermore preferably at least two third (⅔) by molar ratio of the acid component is terephthalic acid. Most preferably at least three fourth (¾) by molar ratio of the acid component is terephthalic acid. These resins enable to prevent a thermal transfer film from fusing to a heat-sensitive transfer image-receiving sheet. The polyester resins used in the present invention may be obtained by a method described in, for example, JP-A-9-295389.

[Heat-Resistant Sliding Layer]

The thermal transfer sheet used in the present invention, preferably the first embodiment of the present invention, has preferably a heat-resistant sliding layer that is formed so as to contain a hardener on one surface of the substrate film, in order to prevent adverse affects such as a stick and printing wrinkles that are caused by heat from a thermal head. The heat-resistant sliding (lubricating) layer that is formed so as to contain a hardener, preferably contains a polymer as a binder. As the polymer, preferably used are thermoplastic resins such as polyester resins, polyacrylate resins, polyvinyl acetate resins, styrene acrylate resins, polyurethane resins, polyolefin resins, polystyrene resins, polyvinyl chloride resins, polyether resins, polyamide resins, polycarbonate resins, polyethylene resins, polypropylene resins, polyacrylamide resins, polyvinyl butyral resins, and polyvinyl acetal resins such as polyvinyl acetoacetal resins, and silicone-modified thereof. Of these polymers, the most preferable resins are polyvinyl butyral resins, polyvinyl acetal resins such as polyvinyl acetoacetal resins, and resins having a hydroxyl group capable of reacting with an isocyanate group, such as silicone-modified thereof.

In a preferred embodiment of the present invention, the above-described resins are preferably used together with a compound having 2 or more isocyanate groups as a cross-linking agent in order to give a heat-resistant sliding layer three properties of thermal resistance, film coating, and adhesion with a substrate. As these isocyanate compounds, there can be used any known isocyanate compounds that are usually employed to synthesize coating compounds, adhesives, polyurethane and the like. For use in the present invention, these isocyanate compounds are also available by a trade name such as Takenate (manufactured by Takeda Pharmaceutical), BURNOCK (manufactured by Dainippon Ink & Chemicals), CORONATE (manufactured by Nippon Polyurethane Industry), DURANATE (manufactured by Asahi Kasei Chemicals), and Dismodule (manufactured by Bayer).

The heat-resistant sliding layer for use in the present invention is a layer that is formed so as to contain a hardener (hardening agent). Herein, the term “a (heat-resistant sliding) layer that is formed so as to contain a hardener” means that the heat-resistant sliding layer is formed by using a coating mixture which contains a hardener, or that the heat-resistant sliding layer is formed by using a coating material containing a resin crosslinked with a hardener. Preferred examples of the hardener include the cross-linking agents (including hardeners) for the receptor layer in the heat-sensitive transfer image-receiving sheet as exemplified in the above.

A suitable addition amount of said isocyanate compound is in the range of 5 to 200 parts by mass based on 100 parts by mass of a polymer binder (resin binder) that constitutes a heat-resistant sliding layer. A ratio of NCO/OH preferably ranges from about 0.8 to about 2.0. Too small content of the isocyanate compound leads to a low cross-linking density, which results in dissatisfactory thermal resistance. Whereas, if the content is too much, disadvantages arise such that (1) it becomes difficult to control shrinkage of a coating film to be formed, (2) a hardening time becomes long, and (3) an unreacted NCO group remains in a heat-resistant sliding layer, and resultantly the remaining NCO group reacts with moisture in air.

Examples of the slip property agent that is added to or coated on the heat-resistant sliding layer composed of the above-described resin include phosphoric esters, silicone oils, graphite powders, silicone-series graft polymers, and silicone polymers such as acrylosiloxane and arylsiloxanes. A preferred layer is composed of an polyol (for example, polyalcohol high molecular compound) and a polyisocyanate compound and a phosphoric ester compound. It is more preferable to add a filler to the layer.

When the heat-resistant sliding layer is formed using the above-described materials in the present invention, there may be incorporated thermal releasing agents or lubricants such as wax, higher fatty acid amides, esters, and surfactants, or organic powders such as fluorocarbon resins, or inorganic particles such as silica, clay, talc, and calcium carbonate, in order to enhance the slip property of the heat-resistant sliding layer.

The heat-resistant sliding layer is formed by the steps of:

solving or dispersing the above-described materials in a suitable solvent such as acetone, methylethyl ketone, toluene, and xylene, to prepare a coating slip; coating and drying the coating slip by a conventional coating means such as a gravure coater, a roll coater, and a wire bar; and then crosslinking the coated layer according to a thermal processing. Herein, the coating amount, namely thickness of the heat-resistant sliding layer is also important. In the present invention, a heat-resistant sliding layer having a satisfactory performance can be formed by controlling the thickness based on a solid content in the range of preferably 2.0 g/m² or less, more preferably from 0.1 to 2.0 g/m², furthermore preferably from 0.1 to 1.0 g/m².

3) Image-Forming Method

In the image-forming method of the present invention, imaging is achieved by superposing a heat-sensitive transfer sheet on a heat-sensitive transfer image-receiving sheet so that a thermal transfer layer of the heat-sensitive transfer sheet can be contacted with a receptor layer of the heat-sensitive transfer image-receiving sheet; and providing thermal energy in accordance with image signals from a thermal head to the superposed two sheets.

As a means for providing heat energy in the thermal transfer, any of the conventionally known providing means may be used. For example, a heat energy of about 5 to 100 mJ/mm² is applied by controlling recording time in a recording device such as a thermal printer (trade name: Video Printer VY-100, manufactured by Hitachi, Ltd.), whereby the expected object can be attained sufficiently. Imaging according to the image-forming method of the present invention can be achieved by the similar manner to that as described in, for example, JP-A-2005-88545.

From the viewpoint of shortening a time taken until a consumer gets a print, in the present invention, preferably the first embodiment of the present invention, a printing time is preferably less than 8 seconds, and further preferably in the range of 3 to 8 seconds. Further, in the present invention, preferably the second embodiment of the present invention, a printing time is preferably less than 15 seconds, further preferably in the range of 3 to 12 seconds, and most preferably in the range of 5 to 8 seconds.

The present invention may be utilized for printers, copying machines and the like utilizing a heat-sensitive transfer recording system.

Advantages of the present invention, preferably the first embodiment of the present invention, are most effectively achieved in the case where a transport speed of the heat-sensitive transfer image-receiving sheet at the time of image formation is in the range of preferably at least 125 mm/s, more preferably from 125 mm/s to 200 mm/s, furthermore preferably from 125 mm/s to 190 mm/s, and most preferably from 125 mm/s to 175 mm/s. Herein, “mm/s” means millimeter per second. Herein, the term “transport speed” of the heat-sensitive transfer image-receiving sheet means the speed with which the heat-sensitive transfer image-receiving sheet reciprocates underneath a thermal head.

Next, a thermal printer that can be used in the thermal sublimation recording or thermal transfer recording is described in detail.

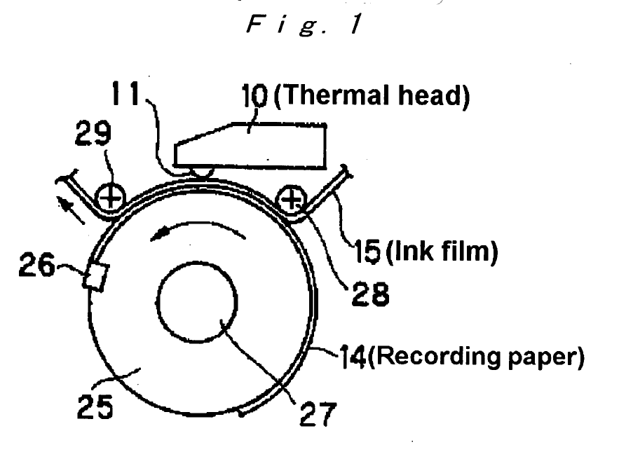

As shown in FIG. 1, for example, a thermal printer is configured so that heat-sensitive transfer recording is performed by passing electric current through an exothermic part (exothermic element array) 11 of a thermal head 10 as a heat-sensitive transfer sheet (ink film) 15 is transported in the direction of the arrow by means of transport rollers (guide rollers) 28 and 29 and the resultant heat-sensitive transfer sheet thus-used is taken up so as to be wound in a ribbon cartridge. In the thermal transfer layer of the heat-sensitive transfer sheet 15, owing to each of a yellow, a magenta and a cyan colorant layer is formed corresponding to the area of the recording surface of a heat-sensitive transfer image-receiving sheet (recording paper) 14, respectively, the heat-sensitive transfer image-receiving sheet 15 is made to reciprocate underneath the thermal head 10 by switching the transport rollers 28 and 29 between the forward and backward rotational directions, and thereby all colors are given to the surface of the recording paper 14. The term “transport speed” of the thermal transfer image-receiving sheet 14 upon the image formation means the speed with which the thermal transfer image-receiving sheet reciprocates underneath the exothermic part 11. In the FIG. 1, numeral 25 represents a platen drum, numeral 26 represents a clamp member, numeral 27, represents a pulse motor.

Also, the heat-sensitive transfer image-receiving sheet of the present invention may be used in various applications enabling thermal transfer recording such as thin sheets or roll-like heat-sensitive transfer image-receiving sheets, cards and transmittable type manuscript-making sheets, by optionally selecting the type of support.

According to the image-forming method of the present invention, preferably the first embodiment of the present invention, a print having a high density and an excellent image quality without a failure such as unevenness and wrinkle can be obtained with neither fusion between a thermal head and an ink sheet, nor fusion between an ink sheet and an image-receiving sheet, even if a high speed printing is performed.

Further, according to the image-forming method of the present invention, preferably the second embodiment of the present invention, a print having an excellent image quality without unevenness can be obtained with no fusion between an ink sheet and an image-receiving sheet, even if a high speed printing is performed.

The present invention will be described in more detail based on the following examples, but the invention is not intended to be limited thereto.

### EXAMPLES

In the following Examples, the terms “part” and “%” are values by mass, unless they are indicated differently in particular.

### Example 1

[Production of an Ink Sheet]

(Production of an Ink Sheet 1101)

A polyester film 6.0 μm in thickness (trade name: Lumirror, manufactured by Toray Industries, Inc.) was used as the substrate film. The following yellow, magenta and cyan compositions are respectively applied as a monochromatic layer (coating amount: 1 g/m² when the layer was dried) on the front side of the film.

<Composition Solution for Dye Layer>

Yellow composition

| | | |
|---|---|---|
| Dye (7)-1 | 2.5 | parts by mass |
| Dye (8)-1 | 2.0 | parts by mass |
| Polyester 1 | 4.5 | parts by mass |
| Methyl ethyl ketone/toluene (1/1, at mass ratio) | 90 | parts by mass |

Magenta composition

| | | |
|---|---|---|
| Dye (9)-1 | 1.0 | parts by mass |
| Dye (10)-1 | 1.0 | parts by mass |
| Dye (11)-1 | 2.5 | parts by mass |
| Polyester 1 | 4.5 | parts by mass |
| Methyl ethyl ketone/toluene (1/1, at mass ratio) | 90 | parts by mass |

Cyan composition

| | | |
|---|---|---|
| Dye (12)-1 | 2.0 | parts by mass |
| Dye (13)-1 | 2.5 | parts by mass |
| Polyester 1 | 4.5 | parts by mass |
| Methyl ethyl ketone/toluene (1/1, at mass ratio) | 90 | parts by mass |

The above-described polyester 1 has the composition set forth below.

(Polyester 1)

Polyester having a number-average molecular weight of 2000, that is obtained by polymerizing the following molar ratio of acid and diol components as described below.

| | |
|---|---|
| Isophthalic acid | 5 |
| Terephthalic acid | 45 |
| Ethyleneglycol | 5 |
| Diethyleneglycol | 45 |

(Production of an Ink Sheet 1102)

As a substrate film, there was used a 6.0 μm thick polyester film (Lumirror, trade name, manufactured by Toray Industries). On a back surface of the film, there was formed a heat-resistant sliding layer (thickness of dried film: 1.0 μm). The ink sheet 1102 was prepared in the same manner as that of the ink sheet 1101, except for the above-described point.

<Composition solution 1 for heat-resistant sliding layer>

| | | |
|---|---|---|
| Polyvinylbutyral resin | 13.6 | parts by mass |
| (S-LEC BX-1, (trade name) manufactured by | | |
| Sekisui Chemical) | | |
| Phosphoric ester | 0.8 | parts by mass |
| (PLY-SURFA208S, (trade name) manufactured | | |
| by DAI-ICHI KOGYOU SEIYAKU) | | |
| Methyl ethyl ketone | 42.9 | parts by mass |
| Toluene | 42.9 | parts by mass |

(Production of an Ink Sheet 1103)

As a substrate film, there was used a 6.0 μm thick polyester film (Lumirror, trade name, manufactured by Toray Industries). On a back surface of the film, there was formed a heat-resistant sliding layer (thickness of dried film: 1.0 μm). The ink sheet 1103 was prepared in the same manner as that of the ink sheet 1101, except for the above-described point.

<Composition solution 2 for heat-resistant sliding layer>

| | | |
|---|---|---|
| Polyvinylbutyral resin | 13.6 | parts by mass |
| (S-LEC BX-1, (trade name) manufactured by | | |
| Sekisui Chemical) | | |
| Polyisocyanate hardening agent | 0.6 | parts by mass |
| (Takenate D218, (trade name) manufactured | | |
| by Takeda Pharmaceutical) | | |
| Phosphoric ester | 0.8 | parts by mass |
| (PLY-SURFA208S, (trade name) manufactured | | |
| by DAI-ICHI KOGYOU SEIYAKU) | | |
| Methyl ethyl ketone | 42.5 | parts by mass |
| Toluene | 42.5 | parts by mass |

[Production of an Image-Receiving Sheet]
(Production of an Image-Receiving Sheet 1201)

Synthetic paper (trade name: Yupo FPG 200, manufactured by Yupo Corporation, thickness: 200 μm) was used as the support to apply a receptor layer having the following composition to one surface of this support. The application was carried out such that the amount of the receptor layer was 4.0 g/m², and the layer was dried at 110° C. for 30 seconds.

<Coating solution 1 for receptor layer>

| | | |
|---|---|---|
| Polybutyl acrylate (manufactured by Aldrich) | 30 | parts by mass |
| Polymethyl methacrylate (manufactured by | 70 | parts by mass |
| Aldrich) | | |
| Amino-modified silicone | 3 | parts by mass |
| (X-22-343 (trade name) manufactured by Shin- | | |
| Etsu Chemical Co., Ltd.) | | |
| Epoxy-modified silicone | 3 | parts by mass |
| (KF-393 (trade name) manufactured by Shin- | | |
| Etsu Chemical Co., Ltd.) | | |
| Toluene/methyl ethyl ketone (1/1, at mass ratio) | 500 | parts by mass |

(Production of an Image-Receiving Sheet 1202)

An image-receiving sheet 1202 was prepared in the same manner as that of the image-receiving sheet 1201, except that the coating solution of the image-receiving sheet was altered as set forth below.

<Coating solution 2 for receptor layer>

| | | |
|---|---|---|
| Vinyl chloride/vinyl acetate copolymer | 100 | parts by mass |
| (# 1000A, (trade name) manufactured by DENKI | | |
| KAGAKU KOGYOU) | | |
| Amino-modified silicone | 3 | parts by mass |
| (X-22-343 (trade name) manufactured by Shin- | | |
| Etsu Chemical Co., Ltd.) | | |
| Epoxy-modified silicone | 3 | parts by mass |
| (KF-393 (trade name) manufactured by Shin-Etsu | | |
| Chemical Co., Ltd.) | | |
| Toluene/methyl ethyl ketone (1/1, at mass ratio) | 500 | parts by mass |

(Production of an Image-Receiving Sheet 1203)

An image-receiving sheet 1203 was prepared in the same manner as that of the image-receiving sheet 1201, except that the coating solution of the image-receiving sheet was altered as set forth below.

<Coating solution 3 for receptor layer>

| | | |
|---|---|---|
| Vinyl chloride/vinyl acetate copolymer | 100 | parts by mass |
| (Solbin A, (trade name) manufactured by Nissin | | |
| Chemical Industry Co., Ltd.) | | |
| Amino-modified silicone | 3 | parts by mass |
| (X-22-343 (trade name) manufactured by Shin- | | |
| Etsu Chemical Co., Ltd.) | | |
| Epoxy-modified silicone | 3 | parts by mass |
| (KF-393 (trade name) manufactured by Shin-Etsu | | |
| Chemical Co., Ltd.) | | |
| Toluene/methyl ethyl ketone (1/1, at mass ratio) | 500 | parts by mass |

[Image Formation]

An image of 152 mm×102 mm size was output by the thermal transfer printer A (DPB1500, trade name, manufactured by Nidec Copal Corporation) or the thermal transfer printer B (the printer described in FIG. 6 of JP-A-5-278247) using the above-described ink sheet and the above-described image-receiving sheet. A transport speed of the printer A was 73 mm/sec. As to the thermal transfer printer B, a transport speed of the heat-sensitive image-receiving sheet at the time of image formation was set to 125 mm/sec so as to perform the Dmax print. Herein, a heating value released from the thermal head of the thermal transfer printer B was controlled so that a density gradation obtained by the thermal transfer printer B could become equal to a density gradation obtained by the thermal transfer printer A. Ten sheets of black solid image were output successively.

Whether there are any fusion and ink peeling in the output image was evaluated according to the criterion set forth below.
5: Neither fusion nor ink peeling are found, and there is almost no unevenness.
4: A little unevenness is found, but neither fusion nor ink peeling are found, and therefore there is no problem in practice.
3: Neither fusion nor ink peeling are found, but apparent unevenness is found, and therefore there is a problem in practice.
2: Both fusion and ink peeling are found, but a print can be released from a printer.
1: An ink sheet and an image-receiving sheet fuse together, so that they are not released from a printer.

Besides, generation of wrinkles was evaluated according to the criterion set forth below.
◯: No generation of wrinkles is found.
Δ: Generation of a few of wrinkles is found.
x: Generation of a lot of wrinkles that will case a practical problem is found.

An average maximum density (Dmax) was evaluated in terms of a reflection density measured using a spectrophotometer (SpectroEye, trade name, manufactured by GretagMacbeth).

The thus-obtained results were shown in Table 1 set forth below.

TABLE 1

| Ink | Image- | Printer A | | | Printer B | | | |
|---|---|---|---|---|---|---|---|---|
| sheet | receiving | Fusion | | Generation | Fusion | | Generation | |
| No. | sheet No. | etc. | Dmax | of wrinkle | etc. | Dmax | of wrinkle | Remarks |
| 1101 | 1201 | 3 | 1.66 | Δ | 1 | 1.52 | X | Comparative |
| | | | | | | | | Example |
| 1102 | 1201 | 4 | 1.64 | Δ | 2 | 1.48 | X | Comparative |
| | | | | | | | | Example |
| 1103 | 1201 | 4 | 1.68 | ◯ | 4 | 1.49 | ◯ | Comparative |
| | | | | | | | | Example |
| 1101 | 1202 | 4 | 1.98 | Δ | 3 | 1.92 | X | Comparative |
| | | | | | | | | Example |
| 1102 | 1202 | 5 | 1.98 | Δ | 3 | 1.92 | X | Comparative |
| | | | | | | | | Example |
| 1103 | 1202 | 5 | 2.02 | ◯ | 5 | 2.00 | ◯ | This invention |
| 1101 | 1203 | 4 | 2.00 | Δ | 3 | 1.96 | X | Comparative |
| | | | | | | | | Example |
| 1102 | 1203 | 5 | 2.00 | Δ | 3 | 1.94 | X | Comparative |
| | | | | | | | | Example |
| 1103 | 1203 | 5 | 2.06 | ◯ | 5 | 2.08 | ◯ | This invention |

As is apparent from the above Table 1, it is recognized that combinations of the ink sheets and the image-receiving sheets according to the present invention are excellent in terms of fusion etc., Dmax and generation of wrinkles, and these advantages are remarkable in the case of a higher transport speed.

### Example 2

[Production of an Ink Sheet]

(Production of an Ink Sheet D1)

A polyester film 6.0 μm in thickness (trade name: Lumirror, manufactured by Toray Industries, Inc.) was used as the substrate film. A heat resistant slip layer (thickness: 1 μm) was formed on the backside of the film, and the following yellow, magenta and cyan compositions are respectively applied as a monochromatic layer (coating amount: 1 g/m² when the layer was dried) on the front side.

Yellow composition

| | | |
|---|---|---|
| Dye (7)-1 | 2.5 | parts by mass |
| Dye (8)-1 | 2.0 | parts by mass |
| Polyvinylbutyral resin | 4.5 | parts by mass |
| (DENKA BUTYRAL (trade name) manufactured by | | |
| Denki Kagaku Kogyou) | | |
| Methyl ethyl ketone/toluene (1/1, at mass ratio) | 90 | parts by mass |

Magenta composition

| | | |
|---|---|---|
| Dye (9)-1 | 1.0 | parts by mass |
| Dye (10)-1 | 1.0 | parts by mass |
| Dye (11)-1 | 2.5 | parts by mass |
| Polyvinylbutyral resin | 4.5 | parts by mass |
| (DENKA BUTYRAL (trade name) manufactured by | | |
| Denki Kagaku Kogyou) | | |
| Methyl ethyl ketone/toluene (1/1, at mass ratio) | 90 | parts by mass |

Cyan composition

| | | |
|---|---|---|
| Dye (12)-1 | 2.0 | parts by mass |
| Dye (13)-1 | 2.5 | parts by mass |
| Polyvinylbutyral resin | 4.5 | parts by mass |
| (DENKA BUTYRAL (trade name) manufactured by | | |
| Denki Kagaku Kogyou) | | |
| Methyl ethyl ketone/toluene (1/1, at mass ratio) | 90 | parts by mass |

(Production of an Ink Sheet D2)

An ink sheet D2 was produced in the same manner as in the production of the ink sheet D1, except that only each of monochromatic ink layers was replaced by the following composition.

Yellow composition

| | | |
|---|---|---|
| Dye (7)-1 | 2.5 | parts by mass |
| Dye (8)-1 | 2.0 | parts by mass |
| Polyvinylbutyral resin | 3.0 | parts by mass |
| (DENKA BUTYRAL (trade name) manufactured by | | |
| Denki Kagaku Kogyou) | | |
| Polyester 4 | 1.5 | parts by mass |
| Methyl ethyl ketone/toluene (1/1, at mass ratio) | 90 | parts by mass |

Magenta composition

| | | |
|---|---|---|
| Dye (9)-1 | 1.0 | parts by mass |
| Dye (10)-1 | 1.0 | parts by mass |
| Dye (11)-1 | 2.5 | parts by mass |
| Polyvinylbutyral resin | 3.0 | parts by mass |
| (DENKA BUTYRAL (trade name) manufactured by | | |
| Denki Kagaku Kogyou) | | |
| Polyester 4 | 1.5 | parts by mass |
| Methyl ethyl ketone/toluene (1/1, at mass ratio) | 90 | parts by mass |

Cyan composition

| | | |
|---|---|---|
| Dye (12)-1 | 2.0 | parts by mass |
| Dye (13)-1 | 2.5 | parts by mass |
| Polyvinylbutyral resin | 3.0 | parts by mass |
| (DENKA BUTYRAL (trade name) manufactured by | | |
| Denki Kagaku Kogyou) | | |
| Polyester4 | 1.5 | parts by mass |
| Methyl ethyl ketone/toluene (1/1, at mass ratio) | 90 | parts by mass |

(Production of an Ink Sheet D3)

An ink sheet D3 was produced in the same manner as in the production of the ink sheet D1, except that only each of monochromatic ink layers was replaced by the following composition.

Yellow composition

| | | |
|---|---|---|
| Dye (7)-1 | 2.5 | parts by mass |
| Dye (8)-1 | 2.0 | parts by mass |
| Polyvinylbutyral resin | 3.0 | parts by mass |
| (DENKA BUTYRAL (trade name) manufactured by | | |
| Denki Kagaku Kogyou) | | |
| Polyester 1 | 1.5 | parts by mass |
| Methyl ethyl ketone/toluene (1/1, at mass ratio) | 90 | parts by mass |

Magenta composition

| | | |
|---|---|---|
| Dye (9)-1 | 1.0 | parts by mass |
| Dye (10)-1 | 1.0 | parts by mass |
| Dye (11)-1 | 2.5 | parts by mass |
| Polyvinylbutyral resin | 3.0 | parts by mass |
| (DENKA BUTYRAL (trade name) manufactured by | | |
| Denki Kagaku Kogyou) | | |
| Polyester 1 | 1.5 | parts by mass |
| Methyl ethyl ketone/toluene (1/1, at mass ratio) | 90 | parts by mass |

Cyan composition

| | | |
|---|---|---|
| Dye (12)-1 | 2.0 | parts by mass |
| Dye (13)-1 | 2.5 | parts by mass |
| Polyvinylbutyral resin | 3.0 | parts by mass |
| (DENKA BUTYRAL (trade name) manufactured by | | |
| Denki Kagaku Kogyou) | | |
| Polyester 1 | 1.5 | parts by mass |
| Methyl ethyl ketone/toluene (1/1, at mass ratio) | 90 | parts by mass |

(Production of an Ink Sheet D4)

An ink sheet D4 was produced in the same manner as in the production of the ink sheet D1, except that only each of monochromatic ink layers was replaced by the following composition.

Yellow composition

| | | |
|---|---|---|
| Dye (7)-1 | 2.5 | parts by mass |
| Dye (8)-1 | 2.0 | parts by mass |
| Polyvinylbutyral resin | 3.0 | parts by mass |
| (DENKA BUTYRAL (trade name) manufactured by | | |
| Denki Kagaku Kogyou) | | |
| Polyester 2 | 1.5 | parts by mass |
| Methyl ethyl ketone/toluene (1/1, at mass ratio) | 90 | parts by mass |

Magenta composition

| | | |
|---|---|---|
| Dye (9)-1 | 1.0 | parts by mass |
| Dye (10)-1 | 1.0 | parts by mass |
| Dye (11)-1 | 2.5 | parts by mass |
| Polyvinylbutyral resin | 3.0 | parts by mass |
| (DENKA BUTYRAL (trade name) manufactured by | | |
| Denki Kagaku Kogyou) | | |
| Polyester 2 | 1.5 | parts by mass |
| Methyl ethyl ketone/toluene (1/1, at mass ratio) | 90 | parts by mass |

Cyan composition

| | | |
|---|---|---|
| Dye (12)-1 | 2.0 | parts by mass |
| Dye (13)-1 | 2.5 | parts by mass |
| Polyvinylbutyral resin | 3.0 | parts by mass |
| (DENKA BUTYRAL (trade name) manufactured by | | |
| Denki Kagaku Kogyou) | | |
| Polyester 2 | 1.5 | parts by mass |
| Methyl ethyl ketone/toluene (1/1, at mass ratio) | 90 | parts by mass |

(Production of an Ink Sheet D5)

An ink sheet D5 was produced in the same manner as in the production of the ink sheet D1, except that only each of monochromatic ink layers was replaced by the following composition.

Yellow composition

| | | |
|---|---|---|
| Dye (7)-1 | 2.5 | parts by mass |
| Dye (8)-1 | 2.0 | parts by mass |
| Polyvinylbutyral resin | 2.0 | parts by mass |
| (DENKA BUTYRAL (trade name) manufactured by | | |
| Denki Kagaku Kogyou) | | |
| Polyester 2 | 2.5 | parts by mass |
| Methyl ethyl ketone/toluene (1/1, at mass ratio) | 90 | parts by mass |

Magenta composition

| | | |
|---|---|---|
| Dye (9)-1 | 1.0 | parts by mass |
| Dye (10)-1 | 1.0 | parts by mass |
| Dye (11)-1 | 2.5 | parts by mass |
| Polyvinylbutyral resin | 2.0 | parts by mass |
| (DENKA BUTYRAL (trade name) manufactured by | | |
| Denki Kagaku Kogyou) | | |
| Polyester 2 | 2.5 | parts by mass |
| Methyl ethyl ketone/toluene (1/1, at mass ratio) | 90 | parts by mass |

Cyan composition

| | | |
|---|---|---|
| Dye (12)-1 | 2.0 | parts by mass |
| Polyvinylbutyral resin | 2.0 | parts by mass |
| (DENKA BUTYRAL (trade name) manufactured by | | |
| Denki Kagaku Kogyou) | | |
| Polyester 2 | 2.5 | parts by mass |
| Methyl ethyl ketone/toluene (1/1, at mass ratio) | 90 | parts by mass |

(Production of an Ink Sheet D6)

An ink sheet D6 was produced in the same manner as in the production of the ink sheet D1, except that only each of monochromatic ink layers was replaced by the following composition.

Yellow composition

| | | |
|---|---|---|
| Dye (7)-1 | 2.5 | parts by mass |
| Dye (8)-1 | 2.0 | parts by mass |
| Polyvinylbutyral resin | 2.0 | parts by mass |
| (DENKA BUTYRAL (trade name) manufactured by | | |
| Denki Kagaku Kogyou) | | |
| Polyester 3 | 2.5 | parts by mass |
| Methyl ethyl ketone/toluene (1/1, at mass ratio) | 90 | parts by mass |

Magenta composition

| | | |
|---|---|---|
| Dye (9)-1 | 1.0 | parts by mass |
| Dye (10)-1 | 1.0 | parts by mass |
| Dye (11)-1 | 2.5 | parts by mass |
| Polyvinylbutyral resin | 2.0 | parts by mass |
| (DENKA BUTYRAL (trade name) manufactured by | | |
| Denki Kagaku Kogyou) | | |
| Polyester 3 | 2.5 | parts by mass |
| Methyl ethyl ketone/toluene (1/1, at mass ratio) | 90 | parts by mass |

Cyan composition

| | | |
|---|---|---|
| Dye (12)-1 | 2.0 | parts by mass |
| Dye (13)-1 | 2.5 | parts by mass |
| Polyvinylbutyral resin | 2.0 | parts by mass |
| (DENKA BUTYRAL (trade name) manufactured by | | |
| Denki Kagaku Kogyou) | | |
| Polyester 3 | 2.5 | parts by mass |
| Methyl ethyl ketone/toluene (1/1, at mass ratio) | 90 | parts by mass |

(Production of an Ink Sheet D7)

An ink sheet D7 was produced in the same manner as in the production of the ink sheet D1, except that only each of monochromatic ink layers was replaced by the following composition.

Yellow composition

| | | |
|---|---|---|
| Dye (7)-1 | 2.5 | parts by mass |
| Dye (8)-1 | 2.0 | parts by mass |
| Polyvinylbutyral resin | 3.0 | parts by mass |
| (DENKA BUTYRAL (trade name) manufactured by | | |
| Denki Kagaku Kogyou) | | |
| Polyester 3 | 1.5 | parts by mass |
| Methyl ethyl ketone/toluene (1/1, at mass ratio) | 90 | parts by mass |

Magenta composition

| | | |
|---|---|---|
| Dye (9)-1 | 1.0 | parts by mass |
| Dye (10)-1 | 1.0 | parts by mass |
| Dye (11)-1 | 2.5 | parts by mass |
| Polyvinylbutyral resin | 3.0 | parts by mass |
| (DENKA BUTYRAL (trade name) manufactured by | | |
| Denki Kagaku Kogyou) | | |
| Polyester 3 | 1.5 | parts by mass |
| Methyl ethyl ketone/toluene (1/1, at mass ratio) | 90 | parts by mass |

Cyan composition

| | | |
|---|---|---|
| Dye (12)-1 | 2.0 | parts by mass |
| Dye (13)-1 | 2.5 | parts by mass |
| Polyvinylbutyral resin | 3.0 | parts by mass |
| (DENKA BUTYRAL manufactured by Denki | | |
| Kagaku Kogyou) | | |
| Polyester 3 | 1.5 | parts by mass |
| Methyl ethyl ketone/toluene (1/1, at mass ratio) | 90 | parts by mass |

(Production of an Ink Sheet D8)

An ink sheet D8 was produced in the same manner as in the production of the ink sheet D1, except that only each of monochromatic ink layers was replaced by the following composition.

Yellow composition

| | | |
|---|---|---|
| Dye (7)-2 | 2.5 | parts by mass |
| Dye (8)-2 | 2.0 | parts by mass |
| Polyvinylbutyral resin | 1.5 | parts by mass |
| (Trade name: S-LEC BX-1, manufactured by | | |
| Sekisui Chemical Co., Ltd.) | | |
| Polyester 3 | 3.0 | parts by mass |
| Methyl ethyl ketone/toluene (1/1, at mass ratio) | 90 | parts by mass |

Magenta composition

| | | |
|---|---|---|
| Dye (9)-2 | 1.0 | parts by mass |
| Dye (10)-2 | 1.0 | parts by mass |
| Dye (11)-2 | 2.5 | parts by mass |
| Polyvinylbutyral resin | 1.5 | parts by mass |
| (Trade name: S-LEC BX-1, manufactured by | | |
| Sekisui Chemical Co., Ltd.) | | |
| Polyester 3 | 3.0 | parts by mass |
| Methyl ethyl ketone/toluene (1/1, at mass ratio) | 90 | parts by mass |

Cyan composition

| | | |
|---|---|---|
| Dye (12)-2 | 2.0 | parts by mass |
| Dye (13)-2 | 2.5 | parts by mass |
| Polyvinylbutyral resin | 1.5 | parts by mass |
| (Trade name: S-LEC BX-1, manufactured by | | |
| Sekisui Chemical Co., Ltd) | | |
| Polyester 3 | 3.0 | parts by mass |
| Methyl ethyl ketone/toluene (1/1, at mass ratio) | 90 | parts by mass |

(Production of an Ink Sheet D9)

An ink sheet D9 was produced in the same manner as in the production of the ink sheet D1, except that only each of monochromatic ink layers was replaced by the following composition.

Yellow composition

| | | |
|---|---|---|
| Dye (7)-1 | 2.5 | parts by mass |
| Dye (8)-1 | 2.0 | parts by mass |
| Polyester 3 | 4.5 | parts by mass |
| Methyl ethyl ketone/toluene (1/1, at mass ratio) | 90 | parts by mass |

Magenta composition

| | | |
|---|---|---|
| Dye (9)-1 | 1.0 | parts by mass |
| Dye (10)-1 | 1.0 | parts by mass |
| Dye (11)-1 | 2.5 | parts by mass |
| Polyester 3 | 4.5 | parts by mass |
| Methyl ethyl ketone/toluene (1/1, at mass ratio) | 90 | parts by mass |

Cyan composition

| | | |
|---|---|---|
| Dye (12)-1 | 2.0 | parts by mass |
| Dye (13)-1 | 2.5 | parts by mass |
| Polyester 3 | 4.5 | parts by mass |
| Methyl ethyl ketone/toluene (1/1, at mass ratio) | 90 | parts by mass |

(Production of an Ink Sheet D10)

An ink sheet D10 was produced in the same manner as in the production of the ink sheet D1, except that only each of monochromatic ink layers was replaced by the following composition.

Yellow composition

| | | |
|---|---|---|
| Dye (7)-2 | 2.5 | parts by mass |
| Dye (8)-2 | 2.0 | parts by mass |
| Polyester 3 | 4.5 | parts by mass |
| Methyl ethyl ketone/toluene (1/1, at mass ratio) | 90 | parts by mass |

Magenta composition

| | | |
|---|---|---|
| Dye (9)-2 | 1.0 | parts by mass |
| Dye (10)-2 | 1.0 | parts by mass |
| Dye (11)-2 | 2.5 | parts by mass |
| Polyester 3 | 4.5 | parts by mass |
| Methyl ethyl ketone/toluene (1/1, at mass ratio) | 90 | parts by mass |

Cyan composition

| | | |
|---|---|---|
| Dye (12)-2 | 2.0 | parts by mass |
| Dye (13)-2 | 2.5 | parts by mass |
| Polyester 3 | 4.5 | parts by mass |
| Methyl ethyl ketone/toluene (1/1, at mass ratio) | 90 | parts by mass |

The above-described polyester is set forth below.

(Polyester 1)

Polyester having a number-average molecular weight of 3000, that is obtained by polymerizing the following molar ratio of acid and diol components as described below.

| | |
|---|---|
| Isophthalic acid | 25 |
| Terephthalic acid | 25 |
| Ethyleneglycol | 5 |
| Diethyleneglycol | 45 |

(Polyester 2)

Polyester having a number-average molecular weight of 2000, that is obtained by polymerizing the following molar ratio of acid and diol components as described below.

| | |
|---|---|
| Isophthalic acid | 10 |
| Terephthalic acid | 40 |
| Ethyleneglycol | 5 |
| Diethyleneglycol | 45 |

(Polyester 3)

Polyester having a number-average molecular weight of 2000, that is obtained by polymerizing the following molar ratio of acid and diol components as described below.

| | |
|---|---|
| Isophthalic acid | 5 |
| Terephthalic acid | 45 |
| Ethyleneglycol | 5 |
| Diethyleneglycol | 45 |

(Polyester 4)

Polyester having a number-average molecular weight of 2000, that is obtained by polymerizing the following molar ratio of acid and diol components as described below.

| | |
|---|---|
| Isophthalic acid | 45 |
| Terephthalic acid | 5 |
| Ethyleneglycol | 5 |
| Diethyleneglycol | 45 |

[Production of an Image-Receiving Sheet]
(Production of an Image-Receiving Sheet R1)

Synthetic paper (trade name: Yupo FPG 200, manufactured by Yupo Corporation, thickness: 200 μm) was used as the support to apply a white intermediate layer and a receptor layer having the following compositions in this order to one surface of this support by a bar coater. The application was carried out such that the amount of the white intermediate layer and the amount of the receptor layer after each layer was dried were 1.0 g/m² and 4.0 g/m², and these layers were respectively dried at 110° C. for 30 seconds. White intermediate layer

| | | |
|---|---|---|
| Polyester resin | 10 | parts by mass |
| (Trade name: Vylon 200, manufactured by Toyobo | | |
| Co., Ltd.) | | |
| Fluuorescent whitening agent | 1 | part by mass |
| (Trade name: Uvitex OB, manufactured by Ciba | | |
| Specialty Chemicals) | | |
| Titanium oxide | 30 | parts by mass |
| Methyl ethyl ketone/toluene (1/1, at mass ratio) | 90 | parts by mass |

Receptor Layer

| | | |
|---|---|---|
| Polyester resin | 100 | parts by mass |
| (Vylon 600 (trade name) manufactured by | | |
| Toyobo Co., Ltd.) | | |
| Amino-modified silicone | 5 | parts by mass |
| (Trade name: X22-3050C, manufactured by Shin- | | |
| Etsu Chemical Co., Ltd.) | | |
| Epoxy-modified silicone | 5 | parts by mass |
| (Trade name: X22-300E, manufactured by Shin- | | |
| Etsu Chemical Co., Ltd.) | | |
| Methyl ethyl ketone/toluene (=1/1, at mass ratio) | 400 | parts by mass |

(Production of an Image-Receiving Sheet R2)

An image-receiving sheet R2 was produced in the same manner as in the production of the image-receiving sheet R1, except that the receptor layer was made to have the following composition.

Receptor Layer

| | | |
|---|---|---|
| Vinyl chloride/vinyl acetate resin | 100 | parts by mass |
| (Trade name: Solbin A, manufactured by Nisshin | | |
| Chemicals Co., Ltd.) | | |
| Amino-modified silicone | 5 | parts by mass |
| (Trade name: X22-3050C, manufactured by Shin- | | |
| Etsu Chemical Co., Ltd.) | | |
| Epoxy-modified silicone | 5 | parts by mass |
| (Trade name: X22-300E, manufactured by Shin- | | |
| Etsu Chemical Co., Ltd.) | | |
| Methyl ethyl ketone/toluene (=1/1, at mass ratio) | 400 | parts by mass |

(Production of an Image-Receiving Sheet R3)

An image-receiving sheet R3 was produced in the same manner as in the production of the image-receiving sheet R1, except that the receptor layer was made to have the following composition.

Receptor Layer

| | | |
|---|---|---|
| Vinyl chloride/vinyl acetate resin | 100 | parts by mass |
| (Trade name: Solbin CL, manufactured by | | |
| Nisshin Chemicals Co., Ltd.) | | |
| Amino-modified silicone | 5 | parts by mass |
| (Trade name: X22-3050C, manufactured by Shin- | | |
| Etsu Chemical Co., Ltd.) | | |
| Epoxy-modified silicone | 5 | parts by mass |
| (Trade name: X22-300E, manufactured by Shin- | | |
| Etsu Chemical Co., Ltd.) | | |
| Methyl ethyl ketone/toluene (=1/1, at mass ratio) | 400 | parts by mass |

[Image Formation]

Ten sheets of black solid image were output successively by the thermal transfer printer A (PBP1500, trade name, manufactured by Nidec Copal Corporation) or the thermal transfer printer B (the printer described in FIG. 6 of JP-A-5-278247) using each of the heat-sensitive transfer sheets and each of the heat-sensitive transfer image-receiving sheets described above. In the thermal transfer printer A, it took 12 seconds to release a print sample from a beginning of a yellow print. In the thermal transfer printer B, the time taken to release a print sample from a beginning of a yellow print was set to 8 seconds, and Dmax (maximum transfer density) print was performed. In this case, a heating value released from the thermal head of the thermal transfer printer B was controlled so that a reflection density obtained by the thermal transfer printer B could become equal to a reflection density obtained by the PBP1500 printer.

Whether there are any fusion and ink peeling in the output image was evaluated according to the criterion set forth below.
5: Neither fusion nor ink peeling are found, and there is almost no unevenness.
4: A little unevenness is found, but neither fusion nor ink peeling are found, and therefore there is no problem in practice.
3: Neither fusion nor ink peeling are found, but apparent unevenness is found, and therefore there is problem in practice.
2: Both fusion and ink peeling are found, but a print can be released from a printer.

1: An ink sheet and an image-receiving sheet fuse together, so that they are not released from a printer.

TABLE 2

| Ink | Image-receiving | | | |
|---|---|---|---|---|
| sheet | sheet | Printer A | Printer B | Remarks |
| D1 | R1 | 3 | 1 | Comparative Example |
| D2 | R1 | 3 | 1 | Comparative Example |
| D1 | R2 | 4 | 2 | Comparative Example |
| D2 | R2 | 4 | 2 | Comparative Example |
| D3 | R1 | 3 | 1 | Comparative Example |
| D3 | R2 | 5 | 5 | This invention |
| D3 | R3 | 5 | 4 | This invention |
| D4 | R2 | 4 | 4 | This invention |
| D5 | R2 | 5 | 4 | This invention |
| D6 | R2 | 5 | 5 | This invention |
| D7 | R2 | 5 | 5 | This invention |
| D8 | R2 | 5 | 5 | This invention |
| D9 | R2 | 5 | 5 | This invention |
| D10 | R2 | 5 | 5 | This invention |
| D10 | R3 | 5 | 4 | This invention |

From the above results, it is found that a combination of the heat-sensitive transfer sheets and the heat-sensitive transfer image-receiving sheets for use in the present invention is excellent.

Having described our invention as related to the present embodiments, it is our intention that the invention not be limited by any of the details of the description, unless otherwise specified, but rather be construed broadly within its spirit and scope as set out in the accompanying claims.

What we claim is:

1. An image-forming method comprising the steps of:
superposing a thermal transfer sheet on a heat-sensitive transfer image-receiving sheet so that the following thermal transfer layer of the thermal transfer sheet can be contacted with the following at least one receptor layer of the heat-sensitive transfer image-receiving sheet; and
providing thermal energy in accordance with image signals given from a thermal head to the superposed two sheets, thereby to form a thermal transfer image;
wherein the thermal transfer sheet is (a) the thermal transfer sheet comprising a thermal transfer layer that contains a thermally transferable color material on one surface of a substrate film and a heat-resistant sliding layer that is formed so as to contain a hardener on the other surface of the substrate film, or (b) the thermal transfer sheet comprising a thermal transfer layer containing a thermally transferable color material and at least one polyester as a binder component, in which at least a half (½) by molar ratio of an acid component of said polyester is terephthalic acid; and
wherein the heat-sensitive transfer image-receiving sheet comprises a support and at least one receptor layer thereon receiving a color material that is transferred from the above-described thermal transfer sheet, said receptor layer containing a polymer comprising at least one repeating unit derived from vinyl chloride or a polymer that at least one repeating unit is a repeating unit of vinyl chloride.

2. The image-forming method according to claim 1, comprising the steps of:
superposing a thermal transfer sheet on a heat-sensitive transfer image-receiving sheet so that the following thermal transfer layer of the thermal transfer sheet can be contacted with the following at least one receptor layer of the heat-sensitive transfer image-receiving sheet; and
providing thermal energy in accordance with image signals given from a thermal head to the superposed two sheets, thereby to form a thermal transfer image;
wherein the thermal transfer sheet comprises a thermal transfer layer that contains a thermally transferable color material on one surface of a substrate film, and a heat-resistant sliding layer that is formed so as to contain a hardener on the other surface of the substrate film, and
wherein the heat-sensitive transfer image-receiving sheet comprises a support and at least one receptor layer thereon containing a polymer comprising at least one repeating unit derived from vinyl chloride.

3. The image-forming method according to claim 2, wherein the above-described heat-resistant sliding layer contains a polymer that is obtained by a reaction between a compound having two or more isocyanate groups and a polymer.

4. The image-forming method according to claim 3, wherein a content of said compound having two or more isocyanate groups in the above-described heat-resistant sliding layer is in the range of 5 to 200 parts by mass based on 100 parts by mass of a polymer binder that constitutes the heat-resistant sliding layer.

5. The image-forming method according to claim 2, wherein a thickness of the above-described heat-resistant sliding layer is in the range of 0.1 to 2.0 μm.

6. The image-forming method according to claim 1, comprising the steps of:
superposing a thermal transfer sheet on a heat-sensitive transfer image-receiving sheet so that the following thermal transfer layer of the thermal transfer sheet can be contacted with the following at least one receptor layer of the heat-sensitive transfer image-receiving sheet; and
providing thermal energy in accordance with image signals given from a thermal head to the superposed two sheets, thereby to form a thermal transfer image;
wherein the thermal transfer sheet comprises a thermal transfer layer containing a thermally transferable color material and at least one polyester as a binder component, in which at least a half (½) by molar ratio of an acid component of said polyester is terephthalic acid; and
wherein the heat-sensitive transfer image-receiving sheet comprises a support and at least one receptor layer thereon receiving a color material that is transferred from the above-described thermal transfer sheet, said receptor layer containing a polymer wherein at least one repeating unit is a repeating unit of vinyl chloride.

7. The image-forming method according to claim 6, wherein at least two third (⅔) by molar ratio of an acid component of the above-described polyester is terephthalic acid.

8. The image-forming method according to claim 6, wherein at least three fourth (¾) by molar ratio of an acid component of the above-described polyester is terephthalic acid.

9. The image-forming method according to claim 1, wherein the above-described thermal transfer sheet contains at least one dye selected from the group consisting of dyes represented by formula (7) and formula (8) set forth below: 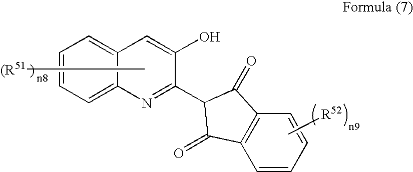
wherein, in formula (7), R⁵¹ and R⁵² each independently represents a substituent; n8 represents an integer of 0 to 5; n9 represents an integer of 0 to 4; when n8 represents an integer of 2 to 5, R⁵'s may be the same or different from each other; and when n9 represents an integer of 2 to 4, R⁵²s may be the same or different from each other; 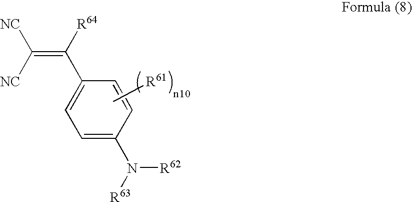
wherein, in formula (8), R⁶¹ represents a substituent; R⁶², R⁶³ and R⁶⁴ each independently represents a hydrogen atom or a substituent; n10 represents an integer of 0 to 4; and when n10 represents an integer of 2 to 4, R⁶'s may be the same or different from each other.

10. The image-forming method according to claim 1, wherein the above-described thermal transfer sheet contains at least one dye selected from the group consisting of dyes represented by formula (9), formula (10) and formula (11) set forth below: 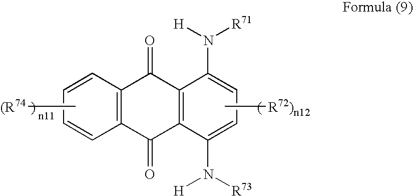
wherein, in formula (9), R⁷¹ and R⁷³ each independently represents a hydrogen atom or a substituent; R⁷² and R⁷⁴ each independently represents a substituent; n11 represents an integer of 0 to 4; n12 represents an integer of 0 to 2; when n11 represents an integer of 2 to 4, R⁷⁴s may be the same or different from each other, and when n12 represents 2, R⁷²s may be the same or different from each other; 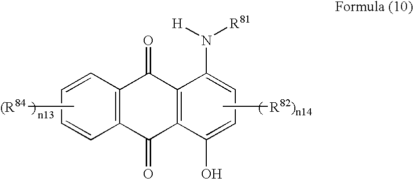
wherein, in formula (10), R⁸¹ represents a hydrogen atom or a substituent; R⁸² and R⁸⁴ each independently represents a substituent; n13 represents an integer of 0 to 4; n14 represents an integer of 0 to 2; when n13 represents an integer of 2 to 4, R⁸⁴s may be the same or different from each other; and when n14 represents 2, R⁸²s may be the same or different from each other; 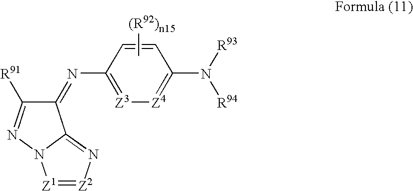
wherein, in formula (11), R⁹¹ represents a hydrogen atom or a substituent; R⁹² represents a substituent; R⁹³ and R⁹⁴ each independently represents a hydrogen atom or a substituent; n15 represents an integer of 0 to 2; when n15 represents 2, R⁹²s may be the same or different from each other; one of Z¹ and Z² represents ═N— and the other represents ═C(R⁹⁵)—; Z³ and Z⁴ each independently represents ═N— or ═C(R⁹⁶)—; and R⁹⁵ and R⁹⁶ each independently represents a hydrogen atom or a substituent.

11. The image-forming method according to claim 1, wherein the above-described thermal transfer sheet contains at least one dye selected from the group consisting of dyes represented by formula (12) and formula (13) set forth below: 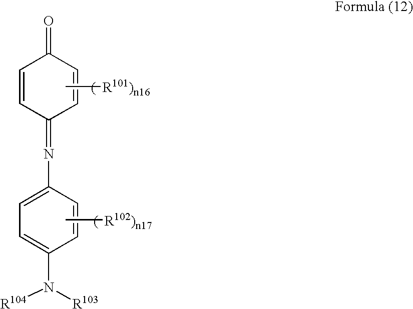
wherein, in formula (12), R¹⁰¹ and R¹⁰² each independently represents a substituent; R¹⁰³ and R¹⁰⁴ each independently represents a hydrogen atom or a substituent; n16 and n17 each independently represents an integer of 0 to 4; when n16 represents an integer of 2 to 4, R¹⁰¹s may be the same or different from each other; and when n17 represents an integer of 2 to 4, R¹⁰²s may be the same or different from each other; 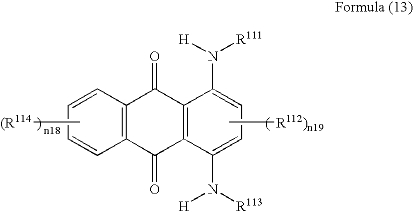
wherein, in formula (13), R¹¹¹ and R¹¹³ each independently represents a hydrogen atom or a substituent; R¹¹² and R¹¹⁴ each independently represents a substituent; n18 represents an integer of 0 to 4; n19 represents an integer of 0 to 2; when n18 represents an integer of 2 to 4, R¹¹⁴s may be the same or different from each other; and when n19 represents 2, R¹¹²s may be the same or different from each other.

12. The image-forming method according to claim 2, wherein a transport speed of the above-described heat-sensitive transfer image-receiving sheet at the time of image formation is at least 125 mm per second.

13. The image-forming method according to claim 1, wherein the polymer used in the receptor layer of the heat-sensitive transfer image-receiving sheet is a vinyl chloride-vinyl acetate copolymer.

14. The image-forming method according to claim 1, wherein the polymer used in the receptor layer of the heat-sensitive transfer image-receiving sheet is a polyvinyl chloride copolymer having a vinyl chloride constituent content of 85 to 97% by mass and a polymerization degree of 200 to 800.

15. The image-forming method according to claim 1, wherein the receptor layer of the heat-sensitive transfer image-receiving sheet comprises a plasticizer.

16. The image-forming method according to claim 1, wherein the receptor layer of the heat-sensitive transfer image-receiving sheet comprises a releasing agent.

17. The image-forming method according to claim 1, wherein an amount of the receptor layer to be applied on the support of the heat-sensitive transfer image-receiving sheet is in the range of 0.5 to 10 g/m² (in solid content equivalent).

18. The image-forming method according to claim 1, wherein an amount of the thermal transfer layer to be applied on the substrate film of the heat-sensitive transfer sheet is in the range of 0.15 to 0.60 g/m² (in solid content equivalent).
